(19) United States
(12) Patent Application Publication
(10) Pub. No.: US 2025/0209464 A1
(43) Pub. Date: Jun. 26, 2025

(54) ARTIFICIAL INTELLIGENCE BASED METHODS AND SYSTEMS FOR PREDICTING OVERALL ACCOUNT-LEVEL RISKS OF CARDHOLDERS

(71) Applicant: MASTERCARD INTERNATIONAL INCORPORATED, PURCHASE, NY (US)

(72) Inventors: Ankur ARORA, New Delhi (IN); Amit KUMAR, New Delhi (IN); Anket Prakash HIRULKAR, Tal- Daryapur (IN); Ankur SARASWAT, Gurgaon (IN); Gaurav DHAMA, Gurgaon (IN); Himanshi CHAROTIA, New Delhi (IN); Janu VERMA, Bengaluru (IN); Kandukuri KARTHIK, Nalgonda (IN); Kanishk GOYAL, Alwar (IN); Kushagra AGARWAL, Gurgaon (IN); Lalasa DHEEKOLLU, Visakhapatnam (IN); Siddhartha ASTHANA, New Delhi (IN); Smriti GUPTA, New Delhi (IN)

(21) Appl. No.: 19/063,282

(22) Filed: Feb. 25, 2025

Related U.S. Application Data
(63) Continuation of application No. 17/739,056, filed on May 6, 2022.

(30) Foreign Application Priority Data
May 8, 2021 (IN) 202141020933

(51) Int. Cl. G06Q 20/40; G06Q 20/36; G06Q 20/38; G06Q 40/03

(52) U.S. Cl. CPC G06Q 20/4016; G06Q 20/36; G06Q 20/389; G06Q 40/03

(57) ABSTRACT

Embodiments provide methods and systems for predicting overall account-level risks of cardholders. The method performed by server system includes accessing payment transaction data associated with a cardholder from a transaction database. Method includes generating a set of transaction features based on a set of transaction indicators. The method includes determining a plurality of network risk scores associated with the cardholder based on the set of transaction features and a set of trained machine learning models. The plurality of network risk scores includes a payment capacity risk score, a contactless payment risk score, and a set of account-level risk scores. The method includes aggregating the plurality of network risk scores to calculate an overall account risk score associated with the cardholder based on a statistical model. The method also includes transmitting a notification to the issuer server associated with the cardholder based on the overall account risk score.

### RELATED APPLICATIONS

This application is a continuation of and claims priority to U.S. Non Provisional application Ser. No. 17/739,056, filed May 6, 2022, which claims priority to Indian Patent Provisional Application No. 20/214,1020933, filed May 8, 2021, which are incorporated herein by reference in their entirety.

### TECHNICAL FIELD

The present disclosure relates to payment account networks and, more particularly to, electronic methods and complex processing systems for predicting overall account-level risks of cardholders based at least on artificial intelligence techniques.

### BACKGROUND

Issuing banks, commonly known as issuers or issuer servers, provide payment instruments such as payment cards (e.g., credit cards, debit cards, prepaid cards, etc.) to their account holders. As the number of account holders associated with an issuing bank increases, it becomes challenging for the issuing bank to manage or control the frauds and/or risks associated with payment transactions made via the payment instruments issued by the issuing bank. Even though there are many existing methods to prevent fraud and/or risk associated with the issuing banks, making improvements in fraud/risk management is an ongoing process.

For the issuing banks, tracking and forecasting financial frauds in payment transactions across the account holders is a very challenging task, and more so, with the wide variety of frauds encountered by these issuing banks. The fraudsters keep on using new and very sophisticated or advanced techniques in online payment account frauds, where such payment transactions do not appear like fraudulent transactions at all, to any of the parties involved in the payment transactions. Moreover, the fraudsters can look and behave exactly like an authentic account holder might be expected to look and behave while performing an online and/or offline transaction.

Additionally, when the fraudsters use multiple channels i.e., combining both online and offline channels, these channels may individually look like fair and acceptable payment transactions, but when considered in combinations, turn out to be fraudulent attacks. Therefore, identifying the payment accounts at risk of upcoming fraudulent activity in the future remains a serious challenge for the financial institutions (e.g., the issuing banks). Apart from such fraudulent payment transactions, there are many kinds of risks from the account holders associated with the issuing banks, including, for example, risks of delinquency in payment charged on credit cards, payment declines due to non-sufficiency of funds (NSF), indulgence in prohibited practices, money laundering, claims of a chargeback, and so on. When the issuing bank has to deal with such frauds or risks for millions of its account holders, it becomes an operational challenge without much error tolerance.

Thus, there exists a need for a technical solution to overcome the above-stated disadvantages.

### SUMMARY

Various embodiments of the present disclosure provide methods and systems for predicting overall account-level risks of cardholders based at least on artificial intelligence techniques.

In an aspect, a computer-implemented method is disclosed. The computer-implemented method performed by a server system includes accessing payment transaction data associated with a cardholder from a transaction database. The payment transaction data includes a set of transaction indicators corresponding to payment transactions performed by the cardholder within a predetermined time period. The method further includes generating a set of transaction features based, at least in part, on the set of transaction indicators. Further, the method includes determining a plurality of network risk scores associated with the cardholder for a prediction window based, at least in part, on the set of transaction features and a set of trained machine learning models. The plurality of network risk scores includes at least one or more of: (a) a payment capacity risk score, (b) a contactless payment risk score, and (c) a set of account-level risk scores. The method also includes aggregating the plurality of network risk scores to calculate an overall account risk score associated with cardholder based, at least in part, on a statistical model. The method includes transmitting a notification to an issuer server associated with the cardholder based, at least in part, on the overall account risk score.

In another aspect, a server system is disclosed. The server system includes a communication interface and a memory including executable instructions. In addition, the server system includes a processor communicably coupled to the memory. The processor is configured to execute the instructions to cause the server system, at least in part, to access payment transaction data associated with a cardholder from a transaction database. The payment transaction data includes a set of transaction indicators corresponding to payment transactions performed by the cardholder within a predetermined time period. The server system is further caused to generate a set of transaction features based, at least in part, on the set of transaction indicators. Furthermore, the server system is caused to determine a plurality of network risk scores associated with the cardholder for a prediction window based, at least in part, on the set of transaction features and a set of trained machine learning models. The plurality of network risk scores includes at least one or more of: (a) a payment capacity risk score, (b) a contactless payment risk score, and (c) a set of account-level risk scores. The server system is also caused to aggregate the plurality of network risk scores to calculate an overall account risk score associated with cardholder based, at least in part, on a statistical model. The server system is caused to transmit a notification to an issuer server associated with the cardholder based, at least in part, on the overall account risk score.

In yet another aspect, a non-transitory computer-readable storage medium is disclosed. The non-transitory computer-readable storage medium includes computer-executable instructions that, when executed by at least a processor of a server system, cause the server system to perform a method. The method includes accessing payment transaction data associated with a cardholder from a transaction database. The payment transaction data includes a set of transaction indicators corresponding to payment transactions performed by the cardholder within a predetermined time period. The method further includes generating a set of transaction features based, at least in part, on the set of transaction indicators. Furthermore, the method includes determining a plurality of network risk scores associated with the cardholder for a prediction window based, at least in part, on the set of transaction features and a set of trained machine learning models. The plurality of network risk scores includes at least one or more of: (a) a payment capacity risk score, (b) a contactless payment risk score, and (c) a set of account-level risk scores. The method also includes aggregating the plurality of network risk scores to calculate an overall account risk score associated with cardholder based, at least in part, on a statistical model. The method includes transmitting a notification to an issuer server associated with the cardholder based, at least in part, on the overall account risk score.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1 illustrates an exemplary representation of an environment related to at least some embodiments of the present disclosure;

FIG. 2 is a simplified block diagram of a server system, in accordance with an embodiment of the present disclosure;

FIG. 3 illustrates a simplified block diagram of a process flow for calculating a payment capacity risk score associated with a cardholder, in accordance with an embodiment of the present disclosure;

FIG. 4A illustrates a simplified block diagram of a process flow for determining an account attrition score associated with the cardholder, in accordance with an embodiment of the present disclosure;

FIG. 4B illustrates a simplified block diagram of a process flow for determining a non-sufficient funds (NSF) decline score associated with the cardholder, in accordance with an embodiment of the present disclosure;

FIG. 5A is a flow chart for determining a probability ranking of utilization of contactless wallet by the cardholder, in accordance with an embodiment of the present disclosure;

FIG. 5B is a flow chart for determining a probability ranking of the cardholder performing a contactless card payment transaction, in accordance with an embodiment of the present disclosure;

FIG. 6 is a process flow chart of a method for calculating an overall account risk score associated with the cardholder, in accordance with an embodiment of the present disclosure;

FIG. 7 represents an example representation of a table representing a plurality of network risk scores along with the overall account risk score for a cardholder, in accordance with an embodiment of the present disclosure;

FIG. 8 is a process flow chart of a computer-implemented method for calculating the overall account risk score associated with the cardholder, in accordance with an embodiment of the present disclosure;

FIG. 9 is a simplified block diagram of a payment server, in accordance with an embodiment of the present disclosure; and

FIG. 10 is a simplified block diagram of an issuer server, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Embodiments of the present disclosure may be embodied as an apparatus, system, method, or computer program product. Accordingly, embodiments of the present disclosure may take the form of an entire hardware embodiment, an entire software embodiment (including firmware, resident software, micro-code, etc.), or an embodiment combining software and hardware aspects that may all generally be referred to herein as a “circuit”, “engine”, “module”, or “system.” Furthermore, aspects of the present disclosure may take the form of a computer program product embodied in one or more computer-readable storage media having computer-readable program code embodied thereon.

The term “payment account” used throughout the description refers to a financial account that is used to fund a financial transaction. Examples of the financial account include, but are not limited to, a savings account, a credit account, a checking account, and a virtual payment account. The financial account may be associated with an entity such as a person, a family, a commercial entity, a company, a corporation, a governmental entity, a non-profit organization, and the like. In some scenarios, the financial account may be a virtual or temporary payment account that can be mapped or linked to a primary financial account, such as those accounts managed by payment wallet service providers, and the like.

The term “payment card”, used throughout the description, refers to a physical or virtual card linked with a financial or payment account that may be presented to a merchant or any such facility to fund a financial transaction via the associated payment account. Examples of the payment card include, but are not limited to, debit cards, credit cards, prepaid cards, virtual payment numbers, virtual card numbers, forex cards, charge cards, e-wallet cards, and stored-value cards. A payment card may be a physical card that may be presented to the merchant for funding the payment. Alternatively, or additionally, the payment card may be embodied in form of data stored in a user device, where the data is associated with payment account such that the data can be used to process the financial transaction between the payment account and a merchant's financial account.

The term “payment network”, used herein, refers to a network or collection of systems used for the transfer of funds through the use of cash-substitutes. Payment networks may use a variety of different protocols and procedures to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by such as, Mastercard®.

The term “merchant”, used throughout the description generally refers to a seller, a retailer, a purchase location, an organization, or any other entity that is in the business of selling goods or providing services, and it can refer to either a single business location, or a chain of business locations of the same entity.

The terms “account holder”, “user”, “cardholder”, and “customer” are used interchangeably throughout the description and refer to a person who has a payment account or a payment card (e.g., credit card, debit card, etc.) associated with the payment account, that will be used by a merchant to perform a payment transaction. The payment account may be opened via an issuing bank or an issuer server.

The terms “issuer bank”, “issuing bank”, “issuer server”, or simply “issuer” are used interchangeably throughout the description and refer to a financial institution in which an account holder may have a payment account, (which also issues a payment card, such as a credit card, debit card, prepaid card, etc.), and provides microfinance banking services (e.g., payment transactions using the payment cards) for processing electronic payment transactions, to the account holder.

The term “overall account risk score”, used throughout the description generally refers to a final risk score calculated based on various individual risk scores associated with a cardholder. In addition, the overall account risk score refers to a most severe or most vulnerable risk that needs immediate attention (i.e., needs to be corrected or rectified immediately) from the issuing bank.

### Overview

Various embodiments of the present disclosure provide methods and systems for determining various risk scores associated with each of a plurality of cardholders associated with an issuing bank. In some embodiments, machine learning techniques can be used to train various machine learning models to determine various risk scores. In addition, an overall account risk score may be calculated based on the various risk scores. The overall account risk score provides information about the most vulnerable or most severe account risk associated with the cardholder that requires immediate attention from an issuer server associated with the cardholder.

Conventionally, it is extremely difficult for the issuer server to manage the frauds or risks associated with the plurality of cardholders (the number of cardholders can be in millions). Once a fraudulent transaction occurs, it consumes up a lot of banking time and useful resources to bring back the funds to the original payment account of the cardholder. It is, therefore, necessary for the issuer server to know in advance about the cardholders that may be vulnerable to attacks or frauds in the future. In addition, using artificial intelligence (AI) based on existing solutions need high technical skills and a lot of resources that may not be always available.

In an example (not in accordance with embodiments of the present disclosure), the frauds or risks associated with the cardholder may include a risk of decline of a payment collection request. The payment collection request may be raised for the collection of funds from the payment account of the cardholder in exchange for any services or goods already purchased by the cardholder. The payment collection request may get declined due to insufficient funds present in the payment account of the cardholder. In general, the initialization of the payment collection request leads to the consumption of useful banking resources and time. Therefore, if the payment collection request gets declined due to insufficient funds present in the payment account of the cardholder, it may lead to the wastage of useful banking resources and time.

In another example (not in accordance with embodiments of the present disclosure), the frauds or risks associated with the cardholder may include risks associated with the utilization of contactless cards to perform payment transactions. In general, contactless payment transactions refer to those payment transactions that are performed in a contactless manner by just tapping the payment card at a device (such as a point of sale (POS) terminal) without the need to enter a personal identification number (PIN) by the cardholder.

In yet another example (not in accordance with embodiments of the present disclosure), the frauds or risks associated with the cardholder may include a risk of reissuance of payment cards due to some fraudulent activity, risk of utilization of the payment card at a risky or compromised merchant (e.g., a common point of purchase (CPP) compromised merchant), risk of a chargeback claim being raised by the cardholder for a payment transaction performed in future, and the like.

Thus, at least one of the technical problems addressed by the present disclosure includes: (a) increasing contactless adoption of payment cards leading to fraudulent activity occurrence, (b) increasing costs of card reissuance due to fraud, and (c) banking resource consumption required in chargeback arbitration.

To overcome such technical problems or limitations, the present disclosure describes a server system that is configured to calculate an overall account risk score based on the plurality of network risk scores associated with the cardholder. In one embodiment, the server system includes at least a processor and a memory. In one non-limiting example, the server system is a payment server associated with a payment network.

Initially, the server system is configured to access payment transaction data associated with the cardholder from a transaction database. The payment transaction data includes a set of transaction indicators corresponding to payment transactions performed by the cardholder within a predetermined time period. The server system is further configured to generate a set of transaction features based, at least in part, on the set of transaction indicators. In one embodiment, the set of transaction features includes at least one of: spend transaction features, merchant features of a plurality of merchants involved in the payment transactions, and fraud risk features. Further, the server system is configured to determine the plurality of network risk scores associated with the cardholder for a prediction window based, at least in part, on the set of transaction features and a set of trained machine learning models. The plurality of network risk scores includes at least one or more of: (a) a payment capacity risk score, (b) a contactless payment risk score, and (c) a set of account-level risk scores. In some embodiments, the payment risk score includes a combination of an account attrition score and a non-sufficient funds (NSF) decline score.

In one embodiment, the payment capacity risk score is determined based, at least in part, on a combination of the account attrition score and the non-sufficient funds (NSF) decline score associated with the cardholder. The contactless payment risk score is determined based, at least in part, on a contactless risk prediction model and a combination of a contactless wallet risk score and a contactless card risk score associated with the cardholder.

To determine the payment capacity risk score, the server system is configured to calculate a credit burst score based, at least in part, on a spend behavioral data of the cardholder. The server system is configured to determine whether the credit burst score is at least equal to (i.e., greater than or equal to) a pre-defined threshold value. In response to determining that the credit burst score is at least equal to the pre-defined threshold value, the server system is configured to determine the account attrition score associated with the cardholder based, at least in part, on an account attrition model. The account attrition score indicates a likelihood of the cardholder being spend inactive within the prediction window.

In response to determining that the credit burst score is at least equal to the pre-defined threshold value, the server system is also configured to determine the NSF decline score associated with the cardholder based, at least in part, on a non-sufficient funds (NSF) prediction model. The NSF decline score indicates a likelihood of having payment declines due to insufficient funds in a payment account of the cardholder within the prediction window. Further, the server system is configured to combine the account attrition score and the NSF probability score based, at least in part, on a rule set to determine the payment capacity risk score associated with the cardholder. The rule set may define a set of rules based on which the payment capacity risk score may be determined from the account attrition score and the NSF decline score. In some embodiments, the account attrition model and the NSF prediction model are trained based at least on a gradient boosting decision tree method.

Moreover, the server system is configured to aggregate the plurality of network risk scores to calculate the overall account risk score associated with cardholder based, at least in part, on a statistical model. To calculate the overall account risk score, the server system is configured to provide the plurality of network risk scores associated with the cardholder as an input to the statistical model. The server system is further configured to determine one or more statistical parameters associated with each of the plurality of network risk scores. Further, the server system is configured to compute a set of z-scores corresponding to the plurality of network risk scores. The server system is configured to compare the set of z-scores to identify a severe account-level risk that is associated with the highest z-score. The “severe account-level risk” herein corresponds to a risk score associated with the cardholder that requires immediate attention from the issuer server. The server system is also configured to categorize the cardholder into a group of one or more pre-defined groups based, at least in part, on the identified severe account-level risk associated with the cardholder. The server system is configured to calculate the overall account risk score associated with the cardholder based on the categorizing step. The server system is configured to transmit a notification to the issuer server associated with the cardholder based, at least in part, on the overall account risk score.

Various embodiments of the present disclosure offer multiple technical advantages and technical effects. For instance, the present disclosure provides a server system configured to perform the prediction of risks or frauds associated with a payment account of a cardholder that may be performed in the future, thus, enabling an issuer server to save valuable banking resources and time. Additionally, the server system facilitates the increased performance of the issuer server as the issuer server is notified about the most vulnerable fraud or risk that may be associated with the cardholder, thus enabling the issuer server to invest valuable banking resources and time for only the most vulnerable risk or fraud. This further leads to reduce costs as the valuable banking resources are only invested in the prevention of the most severe risk or fraud.

The technical improvement in the online payment system as described herein is a computer-based solution to a technical deficiency or problem that is itself rooted in computer technology (e.g., the problem itself derives from the use of computer technology). More specifically, account-level risks due to various risk factors are significant problems for transactions conducted over an electronic payment network, especially for online transactions. Therefore, the present disclosure provides a system to predict an overall account risk score of a cardholder and utilize it in authorization-related tasks such that various frauds or banking resource consumptions for payment transactions can be minimized.

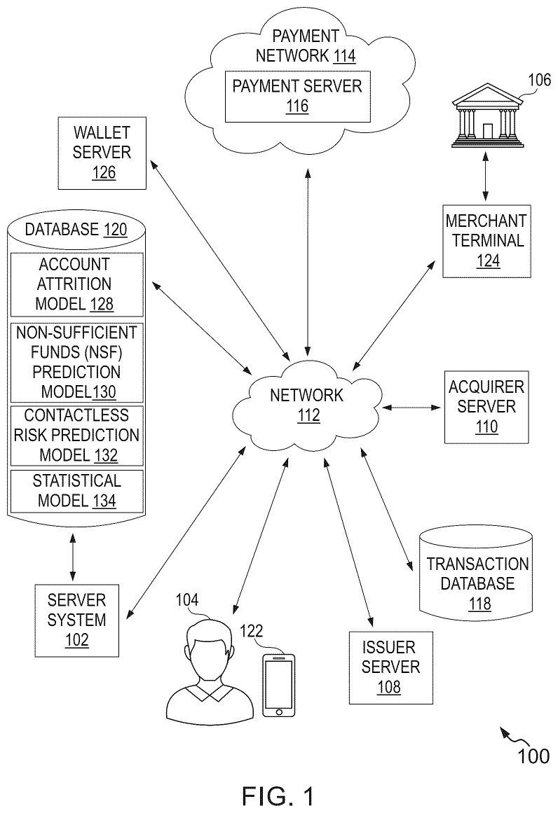

Various example embodiments of the present disclosure are described hereinafter with reference to FIGS. 1 to 10.

FIG. 1 illustrates an exemplary representation of an environment 100 related to at least some embodiments of the present disclosure. Although the environment 100 is presented in one arrangement, other embodiments may include the parts of the environment 100 (or other parts) arranged otherwise depending on, for example, determining risks associated with an account holder, etc. The environment 100 generally includes a plurality of entities, for example, a server system 102, a cardholder 104, a merchant 106, an issuer server 108, an acquirer server 110, a payment network 114 including a payment server 116, a transaction database 118, and a wallet server 126, each coupled to, and in communication with (and/or with access to) a network 112. The network 112 may include, without limitation, a light fidelity (Li-Fi) network, a local area network (LAN), a wide area network (WAN), a metropolitan area network (MAN), a satellite network, the Internet, a fiber-optic network, a coaxial cable network, an infrared (IR) network, a radio frequency (RF) network, a virtual network, and/or another suitable public and/or private network capable of supporting communication among the entities illustrated in FIG. 1, or any combination thereof.

Various entities in the environment 100 may connect to the network 112 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, future communication protocols or any combination thereof. For example, the network 112 may include multiple different networks, such as a private network made accessible by the payment network 114 to the issuer server 108, the acquirer server 110, the payment server 116, and the wallet server 126, separately, and a public network (e.g., the Internet, etc.).

The cardholder 104 may be an individual, representative of a corporate entity, non-profit organization, or any other person. The cardholder 104 may have a payment account issued by corresponding issuing banks (associated with the issuer server 108) and may be provided with a payment card with financial or other account information encoded onto the payment card such that the cardholder 104 may use the payment card to initiate and complete a payment transaction using a bank account at the issuing bank. Examples of the payment card may include, but are not limited to, a smartcard, a debit card, a credit card, and the like.

The environment 100 also includes a user device 122 associated with the cardholder 104. The user device 122 may be a smartphone, a tablet, a laptop, a computer system, or any computing device. In an example, the user device 122 may include a portable device such as a laptop, a tablet, a smartwatch, a PDA (personal digital assistant), a smartphone, and the like. In another example, the user device 122 may include a fixed device such as a desktop, a workstation, and the like. In one implementation, the cardholder 104 may utilize the user device 122 to perform a contactless wallet transaction using a payment wallet managed by the wallet server 126.

In one embodiment, the issuer server 108 is a financial institution that manages accounts of multiple account holders (e.g., the cardholder 104). In addition, account details of the payment accounts established with the issuer bank are stored in account holder profiles of the account holders in memory of the issuer server 108 or on a cloud server associated with the issuer server 108. The terms “issuer server”, “issuer”, or “issuing bank” will be used interchangeably herein.

Moreover, the environment 100 includes a merchant terminal 124 associated with the merchant 106. In addition, the merchant terminal 124 enables the account holders (e.g., the cardholder 104) to perform electronic transactions for purchasing goods and/or services from the merchant 106. The merchant terminal 124 is associated with a unique merchant identifier (MID). Examples of the merchant terminal 124 may include Point-Of-Sale (POS) device, Point-Of-Purchase (POP) device, Point-Of-Interaction (POI) device, or the like. In an implementation, a payment account associated with the merchant 106 may be managed by an acquiring bank (e.g., the acquirer server 110).

In one embodiment, the acquirer server 110 is associated with a financial institution (e.g., a bank) that processes financial transactions. The acquirer server 110 can be an institution that facilitates the processing of payment transactions for the merchant 106, or an institution that owns platforms to make online purchases or purchases made via software applications possible (e.g., shopping cart platform providers and in-app payment processing providers). The terms “acquirer”, “acquirer bank”, “acquiring bank”, or “acquirer server” will be used interchangeably herein.

In one non-limiting example (not in accordance with embodiments of the present disclosure), the cardholder 104 opens a merchant application on the user device 122 to perform a payment transaction using the information of a primary account number (PAN) and/or a payment card associated therewith to purchase goods or services offered by a merchant (e.g., the merchant 106). After submitting a payment from the payment account associated with the payment card, a payment authorization request associated with the submitted payment is authorized in near real-time and the required funds associated with the payment are kept pending for the payment transaction. The funds are debited from the payment account associated with the cardholder 104 and credited in the payment account associated with the merchant 106. The funds are exchanged in place of goods or services provided by the merchant 106 to the cardholder 104.

It is to be noted that there may be various risk factors associated with the payment account of the cardholder 104. In an example, the payment card associated with the cardholder 104 may be stolen and there exists a need for the payment card to be re-issued to the cardholder 104 by the issuer server 108. In another example, the merchant 106 may have to debit a recurring payment from the payment account of the cardholder 104 for a monthly subscription service, but there can be a possibility that appropriate funds are not present in the payment account of the cardholder 104. In such a scenario, raising a debit request to collect the funds from the payment account of the cardholder 104 will lead to the wastage of useful banking resources.

In yet another example, there is a risk that an account holder (e.g., the cardholder 104) may perform a payment transaction at a common point of purchase (CPP) compromised merchant. In such a scenario, the payment account of the cardholder 104 can get compromised after performing the payment transaction at the CPP compromised merchant and may further be used to perform fraudulent payment transactions. In general, CPP is a physical or virtual location of a payment network that is compromised or attacked by fraudsters to steal sensitive information (e.g., payment card information). For example, the CPP may include a compromised automated teller machine (ATM), a breached point-of-sale (POS) device, a malicious payment website for the collection of payment-related information, and the like.

To overcome the above-mentioned limitations, the environment 100 includes the server system 102 that is configured to predict account risks associated with an account holder (e.g., the cardholder 104) and notify the corresponding issuer server 108 about potential future risks or frauds associated with the cardholder 104. The server system 102 provides a holistic understanding of future potential risks associated with the cardholder 104.

The server system 102 is configured to transmit a notification to the issuer server 108. In an implementation, the notification includes an overall account risk score computed based on various network risk scores associated with the cardholder 104. In another implementation, the notification includes a detailed insight report including detailed information about the overall account risk score and the various network risk scores associated with the cardholder 104. The overall account risk score denotes the most vulnerable risk or fraud that can happen in the future from the payment account of the cardholder 104. In general, once a fraud occurs, it may lead to a significant amount of loss of monetary value, time, and computing resources for the issuer server 108. Therefore, the server system 102 is configured to alert the issuer server 108 in advance about the upcoming frauds or risks associated with the cardholder 104. In response, the issuer server 108 can take preventive actions so that the fraud or risk can be eliminated beforehand.

In some embodiments, the server system 102 is configured to implement an account attrition model 128, a non-sufficient funds (NSF) prediction model 130, a contactless risk prediction model 132, and a statistical model 134 to perform one or more of the operations described herein. The server system 102, in communication with the issuer server 108 or the payment server 116, is configured to determine a plurality of network risk scores associated with the cardholder 104 for a prediction window. The server system 102 may further aggregate the plurality of network risk scores to calculate the overall account risk score associated with the cardholder 104. The term “network risk score”, used throughout the description, refers to an account-level risk score associated with a cardholder. In an example, the prediction window may represent any time interval of 3 months, 6 months, 9 months, 12 months, 24 months, and the like.

In one embodiment, the server system 102 coupled with a database 120 is embodied within the payment server 116, however, in other examples, the server system 102 can be a standalone component (acting as a hub) connected to the issuer server 108. The database 120 may store the account attrition model 128, the non-sufficient funds (NSF) prediction model 130, the contactless risk prediction model 132, and the statistical model 134. The database 120 may be incorporated in the server system 102 or may be an individual entity connected to the server system 102 or may be a database stored in cloud storage.

The account attrition model 128 predicts payment accounts that have a high likelihood for transactions as a high risk of fraud with high chances of account closures. The NSF prediction model 130 identifies payment accounts that have a high likelihood of occurrence of insufficient fund declines.

The contactless risk prediction model 132 ranks the payment cards with spending patterns indicating that the contactless card usage can be increased which will further limit the fraud potential using wallet/contactless-enabled cards.

The statistical model 134 is configured to aggregate the plurality of networks risk scores of the cardholder 104 and provide various insights for the issuer server 108 to perform remedial action to reduce fraud.

The transaction database 118 stores information of past payment transactions performed by the cardholders at various merchants. For example, the transaction database 118 may store authorization, clearing, and chargeback data associated with the cardholder 104. The transaction database 118 may store historical transaction data associated with a primary account number (PAN) of the cardholder 104. This information may be transmitted to another computing device, for example, the server system 102 described herein according to various example embodiments.

In some embodiments, the user device 122 is installed with a wallet application (e.g., Web browser, mobile application) that is configured to perform payment transactions through financial amount loaded into the wallet application. The wallet application (not shown in figures) is controlled or managed by a backend server i.e., the wallet server 126. The wallet server 126 is a centralized server that stores account details of a payment account of the cardholder 104 and details of cardholder wallet account in which the cardholder 104 loads the money (i.e., financial amount).

In one embodiment, the payment network 114 may be used by the payment card issuing authorities as a payment interchange network. The payment network 114 may include a plurality of payment servers such as the payment server 116. Examples of payment interchange network include, but are not limited to, Mastercard® payment system interchange network. The Mastercard® payment system interchange network is a proprietary communications standard promulgated by Mastercard International Incorporated® for the exchange of financial transactions among a plurality of financial activities that are members of

Mastercard International Incorporated®. (Mastercard is a registered trademark of Mastercard International Incorporated located in Purchase, N.Y.).

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems (e.g., one or more systems) or a set of devices (e.g., one or more devices) of the environment 100 may perform one or more functions described as being performed by another set of systems or another set of devices of the environment 100.

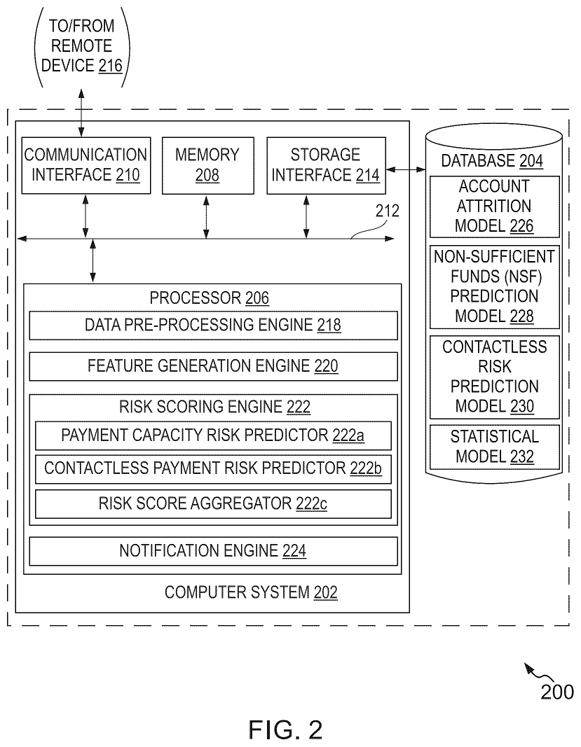

Referring now to FIG. 2, a simplified block diagram of a server system 200 is shown, in accordance with an embodiment of the present disclosure. The server system 200 is identical to the server system 102 of FIG. 1. In some embodiments, the server system 200 is embodied as a cloud-based and/or SaaS-based (software as a service) architecture.

The server system 200 includes a computer system 202 and a database 204. The computer system 202 includes at least one processor 206 for executing instructions, a memory 208, a communication interface 210, and a storage interface 214 that communicate with each other via a bus 212. In some embodiments, the database 204 is integrated within the computer system 202. For example, the computer system 202 may include one or more hard disk drives as the database 204. The storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204. In some embodiments, the database 204 is configured to store an account attrition model 226, a non-sufficient funds (NSF) prediction model 228, a contactless risk prediction model 230, and a statistical model 232.

The account attrition model 226 is identical to the account attrition model 128 of FIG. 1. The NSF prediction model 228 is identical to the NSF prediction model 130 of FIG. 1. The contactless risk prediction model 230 is identical to the contactless risk prediction model 132 of FIG. 1. The statistical model 232 is identical to the statistical model 134 of FIG. 1.

Examples of the processor 206 include, but are not limited to, an application-specific integrated circuit (ASIC) processor, a reduced instruction set computing (RISC) processor, a complex instruction set computing (CISC) processor, graphical processing unit (GPU), a field-programmable gate array (FPGA), and the like. The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the server system 200, as described herein. In another embodiment, the memory 208 may be realized in the form of a database server or cloud storage working in conjunction with the server system 200, without departing from the scope of the present disclosure. The processor 206 is operatively coupled to the communication interface 210 such that the processor 206 is capable of communicating with a remote device 216 such as, the payment server 116, the wallet server 126, the issuer server 108, or communicating with any entity connected to the network 112 (as shown in FIG. 1). In one embodiment, the processor 206 is configured to access payment transaction data associated with the cardholder 104 from the transaction database 118.

It is to be noted that the server system 200 as illustrated and hereinafter described is merely illustrative of an apparatus that could benefit from embodiments of the present disclosure and, therefore, should not be taken to limit the scope of the present disclosure. It is to be noted that the server system 200 may include fewer or more components than those depicted in FIG. 2.

In one embodiment, the processor 206 includes a data pre-processing engine 218, a feature generation engine 220, a risk scoring engine 222 including a payment capacity risk predictor 222a, a contactless payment risk predictor 222b, and a risk score aggregator 222c, and a notification engine 224. It should be noted that components, described herein, such as the data pre-processing engine 218, the feature generation engine 220, the risk scoring engine 222, and the notification engine 224 can be configured in a variety of ways, including electronic circuitries, digital arithmetic and logic blocks, and memory systems in combination with software, firmware, and embedded technologies.

The data pre-processing engine 218 includes suitable logic and/or interfaces for accessing payment transaction data associated with the cardholder 104 from the transaction database 118. In particular, the data pre-processing engine 218 may query the transaction database 118 for past payment transactions of the cardholder 104 based on an account identifier of the cardholder 104. In one embodiment, the data pre-processing engine 218 may obtain the payment transaction data associated with the cardholder 104 from the issuer server 108. The payment transaction data includes a plurality of transaction indicators of payment transactions performed by the cardholder 104 within a predetermined time period. In an example, the predetermined time period may include 3 months, 6 months, 1 year, and the like.

Each payment transaction may include a plurality of transaction indicators. The plurality of transaction indicators includes, but is not limited to, unique merchant identifier, geo-location data, payment means, timestamp information, merchant country, merchant state, merchant city, merchant location ID, transaction amount, transaction currency, acquiring bank, acquiring country, issuing bank, issuing country, card product type, e-commerce indicator, contactless payment indicator, recurring transaction indicator, user presence indicator, cross-border transaction indicator, and the like. The set of transaction indicators may also include authorization, clearing, and chargeback data of the cardholder 104.

In some embodiments, the data pre-processing engine 218 is configured to perform operations (such as data-cleaning, normalization, feature extraction, and the like) on the payment transactions.

The feature generation engine 220 includes suitable logic and/or interfaces for generating a set of transaction features based on the past payment transactions of the cardholder 104. More specifically, the feature generation engine 220 is configured to generate the set of transaction features based, at least in part, on the plurality of transaction indicators. In some embodiments, the set of transaction features or derived data may include at least: (a) account-specific transaction features. The term “account-specific transaction features” herein is used to define transaction features that are generated specific to a payment account of the cardholder 104.

The set of transaction features may be determined from or engineered from the payment transaction data of the past payment transactions. The set of transaction features may include categorical or numerical features. The set of transaction features includes at least one of: spend transaction features, merchant features of a plurality of merchants involved in the payment transactions, and fraud risk features.

In an example, the spend transaction features are card-level or account-level features generated based on payment transactions performed by a cardholder (e.g., the cardholder 104) of the plurality of cardholders. In an example, the merchant features are merchant-level features generated based on the plurality of cardholders that transacted at a merchant (e.g., the merchant 106). In an example, the fraud risk features are generated based on the fraudulent payment transactions.

In one example, the spend transaction features may include a number of payment transactions performed per month for the particular time interval, the amount of spend per payment transaction for the particular time interval, previous transaction count velocity, previous transaction amount velocity, recurring transaction count velocity, transaction count velocity by merchant category, transaction amount velocity according to merchant category, card-present/card-not-present flag, transaction decline count, transaction decline amount, average spend amount in last x days, a number of transactions conducted by the user with a debit card and a number of transactions conducted by the user with a credit card, first transaction decline date, last transaction decline date, and the like.

In one example, the merchant features may include the average spend amount at all merchants (e.g., the merchant 106) in the last 3 months, 6 months, and so on, the number of payment transactions performed at all merchants (e.g., the merchant 106) in the last 3months, 6 months, and so on, average spend amount at CPP compromised merchants (e.g., the merchant 106) in the last 3 months, 6 months, and so on, the number of payment transactions performed at CPP compromised merchants (e.g., the merchant 106) in the last 3 months, 6 months, and so on, number and amount of card-present (CP) or card not present (CNP) performed at all merchants or CPP compromised merchants in the last 3 months, 6 months, and so on, and the like.

In one example, the fraud risk features may include the total fraud amount for CP or CNP cross-border payment transactions performed in the last 1 month, 3 months, and so on, the payment amount for fraudulent payment transactions performed at all merchants (e.g., the merchant 106) in last 1 month, 3 months, and so on, and the like.

In one embodiment, a group of the set of transaction features (i.e., graphical transaction features) may be determined based on a network graph between the cardholder 104 and the plurality of merchants. The network graph captures merchant-cardholder interactions. In other words, some of the set of transaction features are determined based on a graphical representation of the cardholder 104 in view of the risk or spend behavioral profiles of the plurality of merchants.

In one example, the feature generation engine 220 may include a machine learning model such as, but not limited to, Linear Discriminant Analysis (LDA) model, Independent Component Analysis (ICA) model, or Principal Component Analysis (PCA) model to generate the set of transaction features.

In one example, the feature generation engine 220 may use natural language processing (NLP) algorithms to generate the set of transaction features from the set of transaction indicators. It is to be noted that the set of transaction features may be divided into various subsets to be fed as an input to various risk prediction models, including, for example, the account attrition model 226, the non-sufficient funds (NSF) prediction model 228, the contactless risk prediction model 230. In some implementations, the set of transaction features may be converted into a vector format to be fed as an input to the various risk prediction models.

In an example, the set of transaction features to be fed as an input to the account attrition model 226 and the NSF prediction model 228 may include the total transaction count of payment transactions performed by a cardholder (e.g., the cardholder 104) in the last 3 months, 6 months, 9 months, and so on, first transaction date, last transaction date, the total transaction amount of payment transactions performed by a cardholder (e.g., the cardholder 104) in last 3 months, 6 months, 9 months, and so on, total transaction count and total transaction amount of CP or CNP transactions performed at a merchant or all merchants in last 3 months, 6 months, 9 months, and so on, average transaction count and average transaction amount of CP or CNP transactions performed at a merchant or all merchants in last 3 months, 6 months, 9 months, and so on, and the like.

In another example, the set of transaction features to be fed as an input to the account attrition model 226 and the NSF prediction model 228 may include the number and amount of payment transactions performed at terminals (e.g., POS terminals) associated with merchants (e.g., the merchant 106), number and amount of declined payment transactions, the total number of payment accounts opened in last 3 months, 6 months, 9 months, and so on, average number and amount of payment transactions declined due to non-sufficient funds present in the payment accounts of the cardholders (e.g., the cardholder 104), average number and amount of CP or CNP payment transactions declined due to non-sufficient funds present in the payment accounts of the cardholders (e.g., the cardholder 104), and the like.

In yet another example, the set of transaction features to be fed as an input to the account attrition model 226 and the NSF prediction model 228 may include the number and amount of approved payment transactions, average number and amount of approved payment transactions of the cardholders (e.g., the cardholder 104) in last 3 months, 6 months, 9 months, and so on, average number and amount of CP or CNP approved payment transactions of the cardholders (e.g., the cardholder 104) in last 3 months, 6 months, 9 months, and so on, merchant category codes (MCC) of all merchants (e.g., the merchant 106) at which the cardholders (e.g., the cardholder 104) transacted, CP spend in last 3 months, 6 months, 9 months, and so on, CNP spend in last 3 months, 6 months, 9 months, and so on, cross border transactions performed in last 3 months, 6 months, 9 months, and so on, and the like.

In an example, the set of transaction features to be fed as an input to the contactless risk prediction model 230 may include information of payment accounts of cardholders (e.g., the cardholder 104) that transacted at the merchants (e.g., the merchant 106), number and amount of CP payment transactions performed in last 3 months, 6 months, 9 months, 12 months, and so on, number and amount of CNP payment transactions performed in last 3 months, 6 months, 9 months, 12 months, and so on, number and amount of contactless wallet transactions performed by the cardholders (e.g., the cardholder 104) in last 3 months, 6 months, 9 months, 12 months, and so on, number and amount of contactless card transactions performed by the cardholders (e.g., the cardholder 104) in last 3 months, 6 months, 9 months, 12 months, and so on, and the like.

In yet another example, the set of transaction features to be fed as an input to the contactless risk prediction model 230 may include the identification number of the issuer (e.g., the issuer server 108), country code of the issuer (e.g., the issuer server 108), and the like.

The risk scoring engine 222 includes suitable logic and/or interfaces for calculating the overall account risk score of the cardholder 104. In one implementation, the risk scoring engine 222 is configured to determine the plurality of network risk scores associated with the cardholder 104 for the prediction window based, at least in part, on the set of transaction features and a set of trained machine learning models. In some implementations, the plurality of network risk scores includes at least one or more of: (a) a payment capacity risk score, (b) a contactless payment risk score, and (c) a set of account-level risk scores. In some implementations, the set of trained machine learning models includes at least one or more of: (a) the account attrition model 226, (b) the NSF prediction model 228, (c) the contactless risk prediction model 230, and (d) the statistical model 232. In one non-limiting example, the prediction window may include 3 months.

In one embodiment, the payment capacity risk score is a combination of the account attrition score and the non-sufficient funds (NSF) decline score. The payment capacity risk predictor 222a is configured to identify accounts that have a high likelihood of transactions scores as a high risk of fraud and experience insufficient fund declines and account closures. In addition, the payment capacity risk predictor 222a is configured to run the account attrition model 226 and the NSF prediction model 228.

In particular, the payment capacity risk predictor 222a is configured to run the account attrition model 226 and the NSF prediction model 228 to determine the payment capacity risk score. In one implementation, the payment capacity risk score is a risk score that can warn the issuer server 108 of the likelihood of a cardholder (e.g., the cardholder 104) experiencing payment decline due to insufficient funds in the payment account of the cardholder 104. In an embodiment, the payment capacity risk score is determined based on the account attrition score and the non-sufficient funds (NSF) decline score. In one implementation, the account attrition model 226 is responsible for the determination of the account attrition score. In one implementation, the NSF prediction model 228 is responsible for the determination of the NSF decline score.

Initially, the payment capacity risk predictor 222a is configured to calculate a credit burst score associated with the cardholder 104 based at least on spend behavioral data (i.e., spend transaction features) of the cardholder 104. More specifically, the credit burst score may be calculated as: mean+2 sigma, where mean represents the normal spend behavior of the cardholder 104, and sigma represents the deviation from the normal spend behavior of the cardholder 104.

In response to determining that the credit burst score is at least equal to (i.e., greater than equal to) a pre-defined threshold value, the payment capacity risk predictor 222a is configured to assign a score of 1 and further trigger the account attrition model 226, and the NSF prediction model 228.

The payment capacity risk predictor 222a is configured to implement the account attrition model 226 to determine the account attrition score associated with the cardholder 104. In one example, the account attrition score is determined based on past transaction information such as a sudden rise and drop in spending behavior of the cardholder 104 within the last few months. In one implementation, mathematically, the account attrition score may be determined as: 1—(average spend of the cardholder 104 in the upcoming interval of time (e.g., 3 months)/average spend of the cardholder 104 in the past interval of time (e.g., last one year).

In one embodiment, the set of transaction features is fed as an input to the account attrition model 226. In addition, the account attrition model 226 is configured to output the account attrition score associated with the cardholder 104 based on the past transaction data of the cardholder 104. In one non-limiting example, the account attrition model 226 is a gradient boosting decision tree (GBDT) based classification model. In some embodiments, the account attrition model 226 and the NSF prediction model 228 are trained based at least on a gradient boosting decision tree method.

In parallel to the account attrition model 226, the payment capacity risk predictor 222a is configured to implement the NSF prediction model 228. The NSF prediction model 228 is configured to determine the NSF decline score associated with the cardholder 104. The NSF decline score indicates a likelihood of having payment declines due to insufficient funds in a payment account of the cardholder 104 within the prediction window. The NSF prediction model 228 is also configured to receive the set of transaction features as an input and further configured to determine the NSF decline score based on the set of transaction features. In one example, the NSF score warns the issuer server 108 about at least one payment decline in the upcoming interval of time (for example, next 90 days, etc.) due to insufficient funds present in the payment account of the cardholder 104.

A combination of the account attrition model 226 (i.e., the account attrition score) and the NSF prediction model 228 (i.e., the NSF decline score) is used to determine the payment capacity risk score associated with the cardholder 104. In an embodiment, the payment capacity risk score is a geometric mean of the account attrition score and the NSF decline score. In another embodiment, the payment capacity risk score is a weighted average of the account attrition score and the NSF decline score. In yet another embodiment, the payment capacity risk score is calculated based on any other similar combination of the account attrition score and the NSF decline score.

In one non-limiting example, the NSF decline score is a numeric value. In one implementation, the NSF decline score is a three-digit numeric value ranging from 001 to 999, indicative of the probability of the likelihood that the cardholder 104 will face a payment decline due to insufficient funds in the payment account of the cardholder 104 in the prediction window. For example, the NSF decline score of 178 for the prediction window of 3 months indicates that there is a probability of 17.8% that the cardholder 104 will face a payment decline due to insufficient funds in the payment account of the cardholder 104 in the next 3 months.

The contactless payment risk predictor 222b is configured to determine a contactless payment risk score associated with the cardholder 104. The term “contactless payment risk score” herein is used to determine risk scores associated with contactless payments performed by the cardholder 104. The contactless payment risk predictor 222b is configured to determine the contactless payment risk score based, at least in part, on a contactless risk prediction model 230 and a combination of the contactless wallet risk score and the contactless card risk score associated with the cardholder 104. In an example, the contactless payment includes a contactless wallet payment transaction performed by the cardholder 104. In one example, the wallet may be issued and managed by the wallet server 126 of FIG. 1. In another example, the contactless payment includes a contactless card payment transaction performed by the cardholder 104.

In some embodiments, the contactless payment risk score includes a contactless card probability ranking and a contactless wallet probability ranking. In some implementations, each of the contactless card probability ranking and the contactless probability ranking is in a range of 0.0 to 1.0. More specifically, the contactless payment risk predictor 222b is configured to implement the contactless risk prediction model 230 to compute the contactless wallet probability ranking. Similarly, the contactless payment risk predictor 222b is configured to implement the contactless risk prediction model 230 to compute the contactless card probability ranking.

The term “contactless wallet probability ranking” herein refers to a probability ranking indicating a likelihood of utilization of a payment wallet (associated with the wallet server 126) by the cardholder 104 to perform a payment transaction in an upcoming interval of time (e.g., next 30 days, 3 months, 6 months, etc.). The term “contactless card probability ranking” herein refers to a probability ranking indicating a likelihood of the cardholder 104 performing a contactless card payment transaction in the upcoming interval of time (e.g., next 30 days, 3 months, 6 months, etc.).

In one non-limiting example, the contactless risk prediction model 230 is a gradient boosting decision tree (GBDT) based ranking model. In an example, the set of transaction features is provided as an input to the contactless risk prediction model 230, and the contactless risk prediction model 230 is configured to determine two different probability rankings (i.e., contactless wallet probability ranking and contactless card probability ranking) for each cardholder (e.g., the cardholder 104) of the plurality of cardholders. In one example, the contactless risk prediction model 230 may initially be trained using historical transaction data of various cardholders.

In some implementations, the contactless wallet probability ranking is in a range of 001 to 999, where 001 is the lowest probability ranking and 999 is the highest probability ranking. In addition, the contactless wallet probability ranking indicates the relative likelihood of a cardholder (e.g., the cardholder 104) to perform contactless wallet transactions in the prediction window.

In some implementations, the contactless card probability ranking is in a range of 001 to 999, where 001 is the lowest probability ranking and 999 is the highest probability ranking. In addition, the contactless card probability ranking indicates the relative likelihood of a cardholder (e.g., the cardholder 104) to perform contactless card transactions in the prediction window.

In one non-limiting example, the payment capacity risk score is a numeric value. In one implementation, the payment capacity risk score is a three-digit numeric value ranging from 001 to 999, indicative of the probability of the likelihood that the cardholder 104 will face fraudulent activity, insufficient declines, account closure, or the like in the prediction window. For example, the payment capacity risk score of 654 for the prediction window of 3 months indicates that there is a probability of 65.4% that the cardholder 104 will face fraudulent activity, insufficient declines, account closure, or the like in the next 3 months.

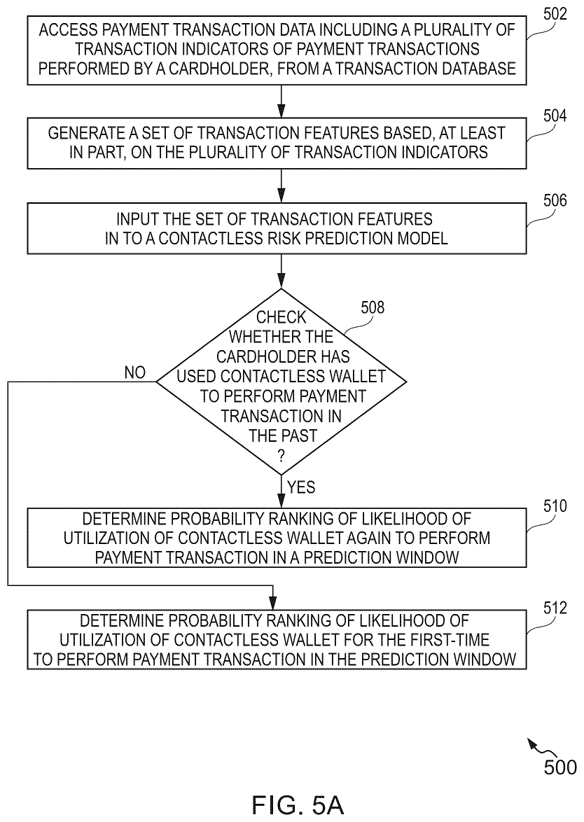

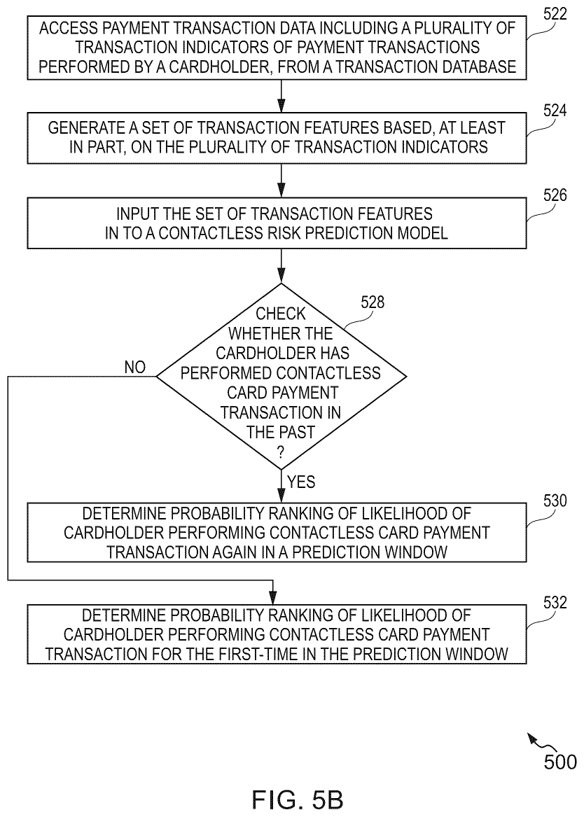

A detailed explanation of the usage of the contactless risk prediction model 230 for the calculation of the contactless card and wallet probability rankings is explained in detail with reference to FIGS. 5A and 5B, and therefore, it is not included herein for the sake of brevity.

The risk score aggregator 222c is further configured to aggregate the plurality of network risk scores to calculate the overall account risk score associated with the cardholder 104 based, at least in part, on the statistical model 232. The plurality of network risk scores may further include a set of account-level risk scores of the cardholder 104. The set of account-level risk scores may include an account reissuance risk score, a transaction channel risk score, and a chargeback risk probability score of the cardholder 104 corresponding to the prediction window. The set of account-level risk scores may be determined based on trained machine learning models. Details of the set of account-level risk scores are provided below:

Account reissuance risk score: The term “account reissuance risk score” herein may refer to a probability or likelihood that a cardholder (e.g., the cardholder 104) may raise a request in the future for reissuance of a payment card associated with the cardholder 104. The cardholder 104 may raise the request for reissuance of the payment card because the payment card might have been compromised before to perform a high-risk or fraudulent transaction and therefore, the payment card needs to be reissued by the issuer server (e.g., the issuer server 108) in a subsequent time period.

In one implementation, the risk scoring engine 222 is configured to execute a trained machine learning model, for example, an account reissuance risk model to output the account reissuance risk score for the cardholder 104. In one non-limiting example, the account reissuance risk model is a GBDT based classification model. Based on spend behavioral pattern features, the account reissuance risk model is configured to calculate the account reissuance risk score associated with the cardholder 104 for the prediction window (e.g., next 3 months, etc.). In an example, the spend behavioral pattern features may include features generated based on historical payment transaction data of the cardholder 104, merchant features associated with CPP compromised merchants, cardholder risk features, payment network related risk features, and the like. In one non-limiting example, the account reissuance risk score is a numeric value. In one implementation, the account reissuance risk score is a three-digit numeric value ranging from 001 to 999, indicative of the probability of likelihood that the cardholder 104 may raise a request for reissuance of the payment card in the prediction window. For example, the account reissuance risk score of 567 for the prediction window of 3 months indicates that there is a probability of 56.7% that the cardholder 104 will raise the request for reissuance of the payment card in the next 3 months.

Chargeback risk probability score: The chargeback risk probability score indicates the likelihood whether an account holder (e.g., the cardholder 104) will raise a chargeback request for a future payment transaction performed within the prediction window. The chargeback risk probability score is calculated based on a chargeback risk prediction model. In one non-limiting example, the chargeback risk prediction model is a GBDT based classification model. Based on the chargeback risk probability score, the chargeback risk prediction model may classify the cardholder 104 as a risky cardholder or a non-risky cardholder. For example, if a chargeback risk probability score computed corresponding to a particular time interval is at least equal to (i.e., greater than or equal to) a predefined threshold value, the cardholder 104 is classified as the risky cardholder, otherwise, when the chargeback probability risk score computed corresponding to the particular time interval is less than the predefined threshold value, the cardholder 104 is classified as the non-risky cardholder. It is to be noted that the predefined threshold values for the set of chargeback risk probability scores may be different.

Further, for the risky cardholder, the risk scoring engine 222 is configured to implement a trained machine learning model, for example, a chargeback amount prediction model to output a chargeback risk level for the risky cardholder. The chargeback risk level indicates a probable chargeback amount range in which the future chargeback amount that may be raised by the risky cardholder lies for the predicted chargeback request. In one non-limiting example, the chargeback amount prediction model is a GBDT based ranking model. Based on the set of chargeback rankings, the chargeback amount prediction model may further classify the cardholder as a high-risk cardholder, medium-risk cardholder, or low-risk cardholder based on the determined chargeback amount range associated with the cardholder.

High-risk channel score: In one implementation, the risk scoring engine 222 is configured to execute a trained machine learning model, for example, a transaction channel risk model to output the high-risk channel score for the cardholder 104. In an example, a third subset of the set of transaction features may be provided as an input to the transaction channel risk model. Based on the third subset of the set of transaction features, the transaction channel risk model is configured to calculate the high-risk channel score for the cardholder 104. The high-risk channel score may be calculated corresponding to an interval of time. In one non-limiting example, the interval of time includes the next 3 months, 6 months, 9 months, 12 months, and the like.

The term “high-risk channel score” herein may refer to a probability of likelihood of a payment card associated with the cardholder (e.g., the cardholder 104) being used to perform a payment transaction at a risky merchant terminal or a CPP compromised merchant in a subsequent time period.

In one non-limiting example, the transaction channel risk model is a binary classification model. Based on the third subset of the set of transaction features, the transaction channel risk model is configured to calculate the high-risk channel score associated with the cardholder 104 for the interval of time (e.g., next 3 months, etc.). The high-risk channel score is indicative of the likelihood that the cardholder 104 will perform a payment transaction at a risky merchant (e.g., CPP compromised merchant) in the next 3 months.

In one implementation, the third subset of the set of transaction features may include features generated based on historical payment transaction data of the cardholder 104, merchant features associated with CPP compromised merchants, cardholder risk features, payment network related risk features, and the like. For example, the third subset of the set of transaction features includes the number of cross-border transactions, amount of cross-border transactions, number of card-present transactions, number of card-not-present transactions, amount of card-present transactions, amount of card-not-present transactions, the number of transactions declined, number and amount of payment transactions performed in the risky country, number amount of payment transactions performed in the non-risky country, merchant category code (MCC) of all merchants at which payment transactions have been performed by the plurality of cardholders, and the like.

To calculate the overall account risk score, the risk score aggregator 222c is configured to provide the plurality of network risk scores associated with the cardholder 104 as an input to the statistical model 232. The risk score aggregator 222c is further configured to determine one or more statistical parameters (e.g., mean, standard deviation, etc.) associated with each of the plurality of network risk scores associated with the cardholder 104. Generally, statistical parameters refer to any measured quantity of a statistical population that summarizes or describes an aspect of the statistical population.

Further, the risk score aggregator 222c is configured to compute the set of z-scores corresponding to the plurality of network risk scores based on the execution of the statistical model 232. It is noted that each z-score corresponds to an individual network risk score of the plurality of network risk scores. For example, a first z-score corresponds to the payment capacity risk score, a second z-score corresponds to the contactless payment risk score, and so on.

Moreover, the risk score aggregator 222c is configured to compare the set of z-scores to identify a severe account-level risk that is associated with the highest z-score. The term “severe account-level risk” herein corresponds to a risk associated with the cardholder 104 that requires immediate attention from the issuer server 108. In one implementation, the severe account-level risk is represented using an alphabet indicative of the most vulnerable or severe risk that may be faced by the cardholder 104 in the future.

The risk score aggregator 222c is configured to categorize the cardholder 104 into a group of one or more pre-defined groups based, at least in part, on the identified severe account-level risk associated with the cardholder 104. In one non-limiting example, the one or more pre-defined groups include group 1, group 2, group 3, and the like. In one example, each group represents a severity ranking associated with the severe account-level risk. Thus, the severe account-level risk represents the corresponding risk from the plurality of network risk scores and the group represents the severity ranking of the corresponding severe account-level risk. Moreover, the risk score aggregator 222c is configured to calculate the overall account risk score associated with the cardholder 104 based on the categorizing step.

In an example, the most severe account-level risk may be represented as “C”. Additionally, the group associated with the severe account-level risk may be represented as “1”. As a result, the overall risk score associated with the cardholder 104 may be represented as “C99”. The value 99 is assigned based on group 1.

In another example, the most severe account-level risk may be represented as “B”. Additionally, the group associated with the severe account-level risk may be represented as “2”. As a result, the overall risk score associated with the cardholder 104 may be represented as “B55”. The value 55 is assigned based on group 2.

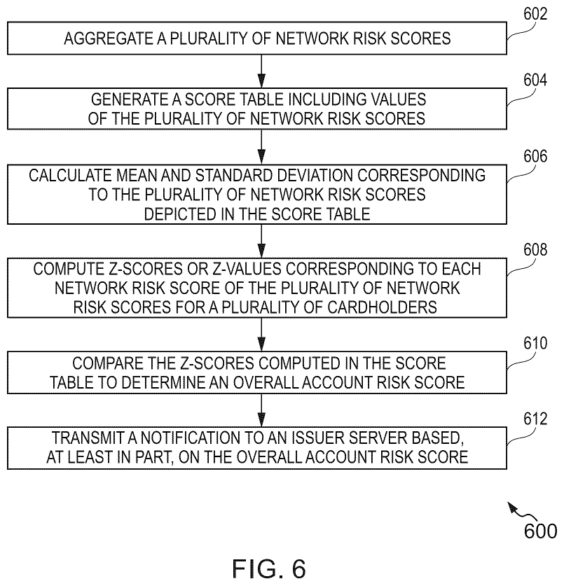

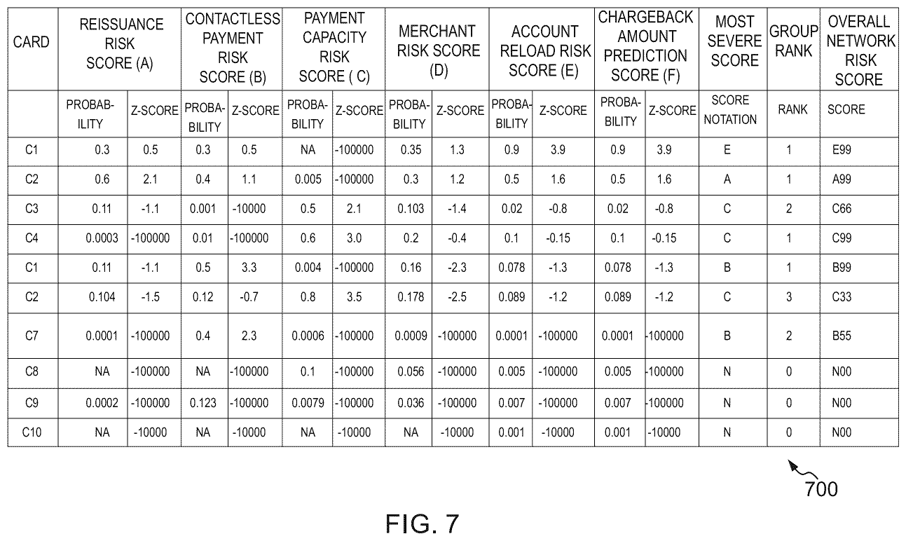

A detailed explanation of calculating the overall account risk score based on the plurality of network risk scores is explained herein with reference to FIGS. 6 and 7, and therefore, it is not reiterated for the sake of brevity.

The notification engine 224 includes suitable logic and/or interfaces for transmitting a notification to the issuer server 108 associated with the cardholder 104 based, at least in part, on the overall account risk score. In addition, the notification engine 224 is configured to transmit the notification to the issuer server 108 associated with the cardholder 104 based, at least in part, on the plurality of network risk scores. Based on the notification, the issuer server 108 may perform one or more downstream tasks such as: (a) identifying cardholder segments that are more likely to file a chargeback, (b) identifying cardholder segments that are most likely to raise a request for re-issuance of payment cards, (c) identifying cardholder segments that may perform contactless wallet or contactless card payment transaction in future, (d) identifying cardholder segments that may see a payment decline due to insufficient funds, (e) identifying cardholder segments that may perform payment transactions at CPP compromised merchants, etc.

In particular, the overall account risk score informs the issuer server 108 in advance about the most probable risk or threat that may be faced by the cardholder 104 in the future. In addition, the risk scoring engine 222 may also provide recommendations to the issuer server 108 about the preventive actions that can be taken in order to prevent the particular risk or fraud. In some embodiments, the risk scoring engine 222 may calculate more than one overall account risk score based on the severity of the risks or threats that may be faced by the cardholder 104 in the future. In one implementation, the overall account risk score is a combination of an alphabet representing the suggested action that should be performed in order to reduce the risk of fraud and a two-digit risk probability indicating the likelihood of the suggested action's effect to prevent fraud.

For example, the overall account risk score of A99 indicates that there is a 99% (i.e., very high) probability that the cardholder 104 will issue a reissuance request for the reissuance of the payment card associated with the cardholder 104.

In particular, the payment capacity risk score helps the issuer server 108 to identify payment accounts that have a high likelihood for payment transactions to be flagged as high risk of fraud, to experience insufficient fund declines, account closures, or the like. In an example, the payment capacity risk score may help to identify payment accounts that may not be able to pay for the goods or services due to insufficient balance in their respective payment accounts. In response, the issuer server 108 may take appropriate actions to avoid such payment accounts (or account holders) from reaching account credit limits or having insufficient funds. In some embodiments, the issuer server 108 may provide recommendations related to financial planning to such cardholders.

In particular, the output of the contactless risk prediction model 230 provides a probability ranking of the utilization of contactless cards and contactless wallets for performing payment transactions by the cardholder 104 in the future. The probability ranking helps the issuer server 108 to determine whether contactless usage can be adopted or increased, which may further limit the fraud potential using a payment wallet. The probability ranking may help to limit the frauds that may be performed using mobile wallets.

In addition, the issuer server 108 may drive increased security by continuing to push engagement of contactless wallets or contactless cards based on the output of the contactless risk prediction model 230. In addition, the issuer server 108 may create cardholder profiles of cardholders (e.g., the cardholder 104) and contactless journey maps to drive enhancements. In some embodiments, the output of the contactless risk prediction model 230 may help to identify the cardholders likely to perform online e-commerce transactions but not using payment wallets. The output of the contactless risk prediction model 230 may further facilitate the issuer server 108 to focus onboarding and card reissuance efforts on only those cardholders that use the payment cards to perform the payment transactions.

In one implementation, the notification engine 224 may transmit notifications or alerts to the issuer server 108 for the cardholders (e.g., the cardholder 104) that are vulnerable to any of the above-stated risks. In one example, the notification engine 224 may transmit the notifications or alerts in real-time when the cardholder 104 is performing a payment transaction in real-time.

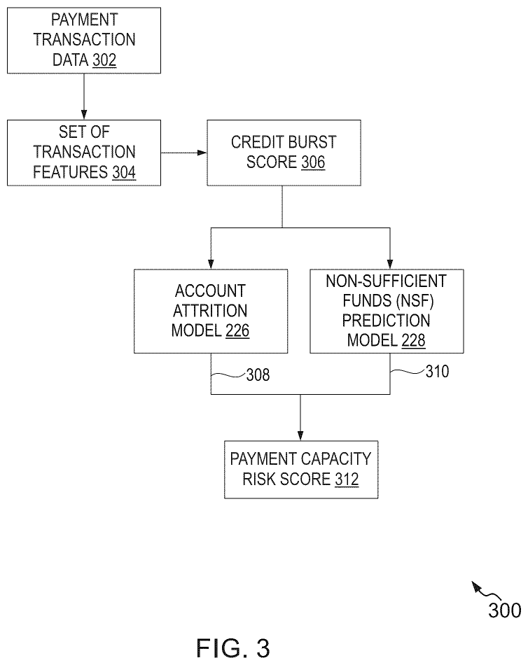

FIG. 3 illustrates a simplified block diagram 300 for calculating a payment capacity risk score associated with the cardholder 104, in accordance with an embodiment of the present disclosure.

As explained above, the processor 206 is configured to determine the payment capacity risk score based on the account attrition score determined via the account attrition model 226 and the NSF decline score determined via the NSF prediction model 228. It is to be noted that the determination of the payment capacity risk score is a complex problem; therefore, to deal with this complex problem efficiently, the payment capacity risk score is divided into two simpler scores i.e., account attrition score and NSF decline score. Both these scores can be easily calculated individually and then these scores are combined to determine or compute the payment capacity risk score.

With reference to the FIG. 3, the processor 206 is configured to access payment transaction data 302 associated with the cardholder 104. In an example, the payment transaction data 302 may be accessed from the transaction database 118. The payment transaction data 302 includes a plurality of transaction indicators of payment transactions performed by the cardholder 104 within a predetermined time period (e.g., 1 year, 2 years, etc.).

The processor 206 is further configured to generate a set of transaction features 304 based, at least in part, on the set of transaction indicators (i.e., the payment transaction data 302). In an example, the processor 206 is configured to generate account-specific transaction features based on the set of transaction indicators. In another example, the processor 206 is configured to generate graphical transaction features based on the set of transaction indicators.

Further, the processor 206 is configured to calculate a credit burst score 306 based, at least in part, on the set of transaction features 304. Mathematically, the credit burst score 306 may be calculated as: Mean+2*sigma, where mean represents the normal spend behavior of the cardholder 104, and sigma represents the deviation from the normal spend behavior of the cardholder 104. In other words, the credit burst score 306 is related to the average transaction amount that may be spent by the cardholder 104 in an interval of time (e.g., prediction window) and the average transaction amount spend by the cardholder 104 in a past interval of time (e.g., last 1 year). The processor 206 is configured to check whether the credit burst score 306 is at least equal to (i.e., greater than or equal to) the pre-defined threshold value. In response to determining that the credit burst score is less than the pre-defined threshold value, the processor 206 is configured to assign a value of 000 and perform nothing thereafter.

Otherwise, in response to determining that the credit burst score 306 is at least equal to (i.e., greater than or equal to) the pre-defined threshold value, the account attrition model 226 is configured to determine an account attrition score 308 associated with the cardholder 104. The account attrition score 308 indicates a likelihood of the cardholder 104 being spend inactive within the prediction window. More specifically, the processor 206 is configured to provide the set of transaction features 304 associated with the cardholder 104 as an input to the account attrition model 226.

In parallel, in response to determining that the credit burst score 306 is at least equal to (i.e., greater than or equal to) the pre-defined threshold value, the NSF prediction model 228 is configured to determine an NSF decline score 310 associated with the cardholder 104. More specifically, the processor 206 is configured to provide the set of transaction features 304 associated with the cardholder 104 as an input to the NSF prediction model 228.

Moreover, the processor 206 is configured to determine a payment capacity risk score 312 associated with the cardholder 104 based on the account attrition score 308 and the NSF decline score 310. In one implementation, the processor 206 is configured to process the account attrition score 308 and the NSF decline score 310, and then calculate the payment capacity risk score 312. In an example, the payment capacity risk score 312 is a weighted average of the account attrition score 308 and the NSF decline score 310. In another example, the payment capacity risk score 312 is a geometric mean of the account attrition score 308 and the NSF decline score 310.

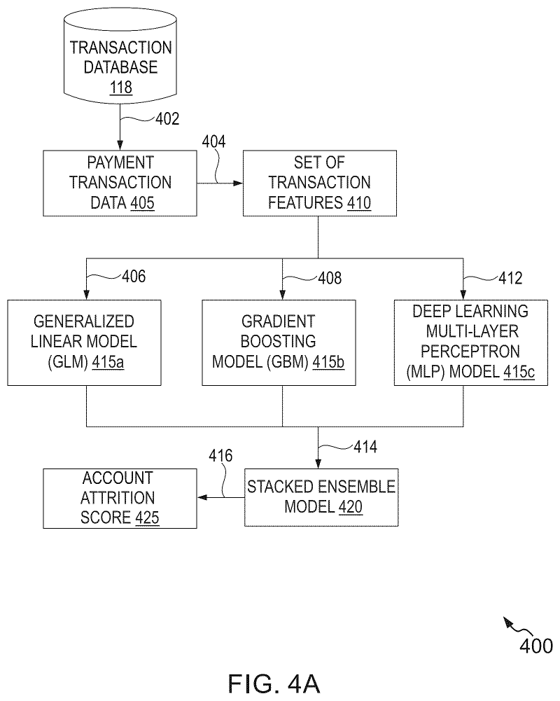

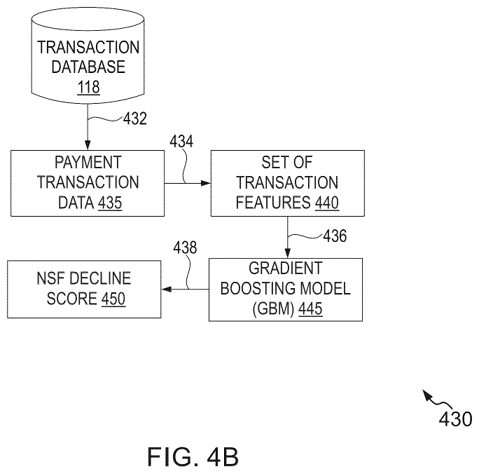

FIG. 4A illustrates a simplified block diagram 400 of a process flow for determining the account attrition score associated with the cardholder 104, in accordance with an embodiment of the present disclosure.

With reference to the FIG. 4A, the processor 206 is configured to access a payment transaction data 405 associated with the cardholder 104 from the transaction database 118 (see, 402). The payment transaction data includes the plurality of transaction indicators of payment transactions performed by the cardholder 104 within a predetermined time period (e.g., 1 year, 2 years, etc.). The processor 206 is further configured to generate a set of transaction features 410 based, at least in part, on the set of transaction indicators (i.e., the payment transaction data 405) (see, 404).

In an implementation, the processor 206 is configured to provide the set of transaction features 410 as an input to a generalized linear model (GLM) 415a (see, 406). Alternatively, or additionally, the processor 206 is configured to provide the set of transaction features 410 as an input to a gradient boosting model (GBM) 415b (see, 408). Alternatively, or additionally, the processor 206 is also configured to provide the set of transaction features 410 as an input to a deep learning multi-layer perceptron (MLP) model 415c (see, 412).

The outputs from the GLM 415a, the GBM 415b and the deep learning MLP model 415c are further fed as an input to a stacked ensemble model 420 (see, 414). Further, the stacked ensemble model 420 processes all the three inputs (i.e., output from the GLM 415a, output from the GBM 415b, and the output from the deep learning MLP model 415c) and then determines an account attrition score 425 associated with the cardholder 104 as an output (see, 416).

In general, a generalized linear model (GLM) is a flexible generalization of ordinary linear regression. In addition, the GLM 415a generalizes linear regression by allowing a linear model to be related to a response variable via a link function and by allowing the magnitude of the variance of each measurement to be a function of its predicted value.

In general, the gradient boosting model (GBM) uses machine learning techniques to perform tasks including, for example, regression and classification. In one implementation, the GBM 415b is a prediction model that uses an ensemble of weak prediction models (e.g., decision trees) to perform prediction tasks. Generally, gradient boosting models outperform random forest models.

In general, multi-layer perceptron (MLP) is a subset of deep neural networks (DNN), and therefore, the deep learning MLP model 415c is an MLP model based on deep neural networks (DNNs). In general, MLP is a fully connected class of feed-forward artificial neural network (ANN). Generally, MLP includes three layers, an input layer, a hidden layer, and an output layer. In addition, MLPs are trained using a supervised learning technique known as back-propagation. In general, a deep neural network (DNN) is an artificial neural network (ANN) with multiple layers between the input layers and the output layers.

FIG. 4B illustrates a simplified block diagram 430 of a process flow for determining a non-sufficient funds (NSF) decline score associated with the cardholder 104, in accordance with an embodiment of the present disclosure.

The processor 206 is configured to access a payment transaction data 435 associated with the cardholder 104 from the transaction database 118 (see, 432). The payment transaction data 435 includes the plurality of transaction indicators of payment transactions performed by the cardholder 104 within a predetermined time period (e.g., 1 year, 2 years, etc.). The processor 206 is further configured to generate a set of transaction features 440 based, at least in part, on the set of transaction indicators (i.e., the payment transaction data 435) (see, 434).

In an implementation, the processor 206 is configured to provide the set of transaction features 440 as an input to a gradient boosting model (GBM) 445 (see, 436). The GBM 445 processes the payment transaction data 435 (i.e., the set of transaction features 440) to output an NSF decline score 450 (see, 438). In an example, the NSF decline score 450 is a score indicative of a likelihood of having payment declines due to insufficient funds in a payment account of the cardholder 104 within the prediction window. In another example, the NSF decline score 450 is a score indicative of at least one payment transaction decline due to non-sufficient funds in the payment account of the cardholder 104 in a pre-defined interval of time (for example, the prediction window). More specifically, the NSF decline score 450 indicates whether a cardholder (e.g., the cardholder 104) will face payment declines due to non-sufficient funds present in the payment account of the cardholder 104 in the prediction window.

FIG. 5A is a flow chart 500 for determining a probability ranking of the utilization of contactless wallet by the cardholder 104, in accordance with an embodiment of the present disclosure. In an implementation, the processor 206 is configured to determine the probability ranking of the utilization of a contactless wallet by the cardholder 104 for performing a payment transaction in the pre-defined interval of time (e.g., the prediction window). In another implementation, the processor 206 is configured to determine various probability rankings corresponding to various cardholders, where each probability ranking corresponds to the utilization of contactless wallets by each cardholder for performing a payment transaction in the pre-defined interval of time (e.g., the prediction window).

At 502, the processor 206 is configured to access payment transaction data associated with the cardholder 104 from the transaction database 118. The payment transaction data includes a plurality of transaction indicators of payment transactions performed by the cardholder 104 within a predetermined time period (e.g., last 1 year, 2 years, etc.).

At 504, the processor 206 is configured to generate the set of transaction features based, at least in part, on the plurality of transaction indicators. In an example, the set of transaction features is generated based on the payment transactions performed in various industries, payment amount spend in various industries, wallets used to perform payment transactions, and the like.

After generation of the set of transaction features, at 506, the processor 206 is configured to input the set of transaction features to the contactless risk prediction model 230. In one implementation, the contactless risk prediction model 230 is a gradient boosting model (GBM). In an example, the GBM model is a gradient boosting decision tree (GBDT) based ranking model. Before execution, the GBM model is trained based on historical transaction data of various cardholders. The historical transaction data includes information of payment transactions performed by the various cardholders within an interval of time. More specifically, the processor 206 is configured to access the historical transaction data of a plurality of cardholders from a database (e.g., the transaction database 118) for an interval of time. The interval of time may include 6 months, 12 months, 2 years, and the like. The historical transaction data includes one or more transaction indicators of payment transactions performed by the plurality of cardholders in the interval of time. Examples of the GBM model include FastTree, XGBoost, AdaBoost, etc.

In general, boosting refers to the ensemble learning technique of building many models sequentially, where each new model tries to correct or rectify the errors in the previous model. In an example, the GBM model implements boosting process to yield accurate models.

The processor 206 is further configured to generate one or more transaction features based, at least in part, on one or more transaction indicators. The process of generating the one or more transaction features may include filtering, transforming, normalizing, or processing the data to be used with the contactless risk prediction model 230. In one implementation, the processor 206 is also configured to determine a vector representation for each transaction feature on a timely basis (e.g., weekly, monthly, half-yearly, etc.) of the plurality of cardholders. For example, a feature vector is generated for each transaction feature on a weekly basis.

Further, the processor 206 is configured to train the contactless risk prediction model 230 based, at least in part, on the vector representation of each transaction feature of the plurality of cardholders. The contactless risk prediction model 230 may use the historical payment transactions as the training examples for calculating a contactless wallet risk probability ranking corresponding to an interval of time or a forward-looking time interval for the cardholder 104. In one embodiment, the processor 206 is configured to train the contactless risk prediction model 230 until a loss function reaches a predetermined threshold value. In one non-limiting example, the loss function is a cross-entropy (CE) loss function.

At 508, the processor 206 is configured to check whether the cardholder 104 has used contactless wallets to perform payment transactions in the past. In an example, the processor 206 is configured to access the historical transaction data of the cardholder 104 to check whether the cardholder 104 used contactless wallets to perform the payment transactions in the past.

If yes, at 510, the contactless risk prediction model 230 is configured to determine a probability ranking of the likelihood of utilization of the contactless wallet again for performing the payment transaction within the prediction window. The probability ranking indicates whether the cardholder 104 will utilize the payment wallet again to perform a payment transaction in the prediction window. In one implementation, the probability ranking determined by the processor 206 is compared with a first threshold level. If the probability ranking is at least equal to (i.e., greater than or equal to) the first threshold level, the processor 206 determines that the cardholder 104 is likely to utilize the payment wallet to perform the payment transaction in the prediction window. Otherwise, if the probability ranking is less than the first threshold level, the processor 206 determines that the cardholder 104 is likely to not utilize the payment wallet to perform the payment transaction in the prediction window.

Otherwise, at 512, if it is determined that the cardholder 104 has not used any contactless wallet before to perform the payment transaction in the past, the contactless risk prediction model 230 is configured to determine the probability ranking of the likelihood of utilization of the contactless wallet for the first time by the cardholder 104 to perform the payment transaction within the prediction window. More specifically, the probability ranking depicts the probability of the cardholder 104 utilizing the contactless wallet for the first time in the prediction window. In some embodiments, the prediction window may be of the next three months, next six months, next nine months, and the like.

In one implementation, the probability ranking determined by the processor 206 is compared with a first threshold level. If the probability ranking is at least equal (i.e., greater than or equal to) the first threshold level, the processor 206 determines that the cardholder 104 is likely to utilize the payment wallet for the first time to perform the payment transaction in the prediction window. Otherwise, if the probability ranking is less than the first threshold level, the processor 206 determines that the cardholder 104 is not likely to utilize the payment wallet for the first time to perform the payment transaction in the prediction window.

FIG. 5B is a flow chart 520 for determining a probability ranking of the cardholder 104 performing a contactless card payment transaction, in accordance with an embodiment of the present disclosure. In an implementation, the processor 206 is configured to determine the probability ranking of the utilization of a contactless card payment transaction by the cardholder 104 in the prediction window (e.g., 1 month, 3 months, etc.). In another implementation, the processor 206 is configured to determine various probability rankings corresponding to various cardholders, where each probability ranking corresponds to the likelihood of utilization of contactless card payment transactions by each cardholder in the prediction window (e.g., 3 months, etc.). The term “contactless card payment transaction” herein refers to payment transactions performed using payment cards (e.g., credit cards, debit cards, etc.) with RFID technology without the need to swipe, or enter the personal identification number (PIN), and/or sign for a payment transaction. In general, RFID or radio frequency identification is a wireless system including two components namely tags and readers. Additionally, a reader is a device that has one or more antennas that emit radio waves and receive signals back from the RFID tag.

At 522, the processor 206 is configured to access payment transaction data associated with the cardholder 104 from the transaction database 118. The payment transaction data includes a plurality of transaction indicators of payment transactions performed by the cardholder 104 within a predetermined time period (e.g., last 1 year, 2 years, etc.).

At 524, the processor 206 is configured to generate the set of transaction features based, at least in part, on the plurality of transaction indicators. In an example, the set of transaction features is generated based on the payment transactions performed in various industries, payment amount spend in various industries, wallets used to perform payment transactions, and the like.

After generation of the set of transaction features, at 526, the processor 206 is configured to input the set of transaction features to the contactless risk prediction model 230. In one implementation, the contactless risk prediction model 230 is a gradient boosting model (GBM). In an example, the GBM model is a gradient boosting decision tree (GBDT) based ranking model. Before execution, the GBM model is trained based on historical transaction data of various cardholders. The historical transaction data includes information of payment transactions performed by the various cardholders within an interval of time. More specifically, the processor 206 is configured to access the historical transaction data of a plurality of cardholders from a database (e.g., the transaction database 118) for an interval of time. The interval of time may include 6 months, 12 months, 2 years, and the like. The historical transaction data includes one or more transaction indicators of payment transactions performed by the plurality of cardholders in the interval of time. Examples of the GBM model include FastTree, XGBoost, AdaBoost, etc.

In one implementation, the XGBoost model provides a parallel tree boosting. In general, boosting refers to the ensemble learning technique of building many models sequentially, where each new model tries to correct or rectify the errors in the previous model. In an example, the GBM model implements boosting process to yield accurate models.

The processor 206 is further configured to generate one or more transaction features based, at least in part, on one or more transaction indicators. The process of generating the one or more transaction features may include filtering, transforming, normalizing, or processing the data to be used with the contactless risk prediction model 230. In one implementation, the processor 206 is also configured to determine a vector representation for each transaction feature on a timely basis (e.g., weekly, monthly, half-yearly, etc.) of the plurality of cardholders. For example, a feature vector is generated for each transaction feature on a weekly basis.

Further, the processor 206 is configured to train the contactless risk prediction model 230 based, at least in part, on the vector representation of each transaction feature of the plurality of cardholders. The contactless risk prediction model 230 may use the historical payment transactions as the training examples for determining a contactless card risk probability ranking corresponding to a forward-looking time interval (i.e., the prediction window) for the cardholder 104. In one embodiment, the processor 206 is configured to train the contactless risk prediction model 230 until a loss function reaches a predetermined threshold value. In one non-limiting example, the loss function is a cross-entropy (CE) loss function.

At 528, the contactless risk prediction model 230 is configured to check whether the cardholder 104 has performed contactless card payment transactions in the past. In an example, the contactless risk prediction model 230 is configured to access the historical transaction data of the cardholder 104 to check whether the cardholder 104 performed contactless card payment transactions in the past.

If yes, at 530, the contactless risk prediction model 230 is configured to determine a probability ranking of the likelihood of the cardholder 104 performing the contactless card payment transaction again in the prediction window. The probability ranking indicates whether the cardholder 104 will perform the contactless card payment transaction again in the prediction window (for example, in the next 3 months).

In one implementation, the probability ranking determined by the processor 206 is compared with a second threshold level. If the probability ranking is at least equal to (i.e., greater than or equal to) the second threshold level, the processor 206 determines that the cardholder 104 is likely to perform the contactless card payment transaction again in the prediction window. Otherwise, if the probability ranking is less than the second threshold level, the processor 206 determines that the cardholder 104 is not likely to perform the contactless card payment transaction again in the prediction window.

Otherwise, at 532, When it is determined that the cardholder 104 has not performed any contactless card payment transaction in the past, the contactless risk prediction model 230 is configured to determine the probability ranking of the likelihood of the cardholder 104 performing the contactless card payment transaction for the first time in the prediction window. More specifically, the probability ranking depicts the probability of the cardholder 104 performing the contactless card payment transaction for the first time in the prediction window. In some embodiments, the prediction window may be of the next three months, next six months, next nine months, and the like.

In one implementation, the probability ranking determined by the processor 206 is compared with the second threshold level. When the probability ranking is at least equal (i.e., greater than or equal to) the second threshold level, the processor 206 determines that the cardholder 104 is likely to perform the contactless card payment transaction for the first time in the prediction window. Otherwise, when the probability ranking is less than the second threshold level, the processor 206 determines that the cardholder 104 is not likely to perform the contactless card payment transaction for the first time in the prediction window.

In one embodiment, the probability ranking for the cardholder 104 for the prediction window is in a range of 0.0 to 1.0. In an example, if the probability ranking of performing the contactless card payment transaction for a cardholder ‘A’ for the next 3 months is 0.587, there is a 58.7% probability that the cardholder ‘A’ will utilize the payment card to perform a contactless card payment transaction in the next 3 months. In another example, if the probability ranking of performing the contactless card payment transaction for a cardholder B for the next 30 days is 0.958, there is a 95.8% probability that the cardholder B will utilize the payment card to perform a contactless card payment transaction in the next 30 days.

FIG. 6 is a process flow chart of a method 600 for calculating an overall account risk score associated with the cardholder 104, in accordance with an embodiment of the present disclosure. The sequence of operations of the method 600 may not be necessarily executed in the same order as they are presented. Further, one or more operations may be grouped and performed in the form of a single step, or one operation may have several sub-steps that may be performed in parallel or in a sequential manner. Operations of the method 600, and combinations of operations in the method may be implemented by, for example, hardware, firmware, a processor, circuitry, and/or a different device associated with the execution of software that includes one or more computer program instructions. The process flow starts at operation 602.

At 602, the server system 200 aggregates the plurality of network risk scores. The plurality of network risk scores may include, but is not limited to, the payment capacity risk score, the contactless payment risk score, and the set of account-level risk scores.

At 604, the server system 200 generates a score table including the values of the plurality of network risk scores. In an example, rows in the score table represent unique cardholder identifiers to identify the plurality of cardholders, and the columns in the score table represent values of the plurality of network risk scores for the corresponding plurality of cardholders. In another example, columns in the score table represent unique cardholder identifiers to identify the plurality of cardholders and the rows in the score table represent values of the plurality of network risk scores for the corresponding plurality of cardholders.

At 606, the server system 200 calculates the mean and standard deviation corresponding to the plurality of network risk scores depicted in the score table. More specifically, the server system 200 calculates a value of mean and standard deviation corresponding to each network risk score of the plurality of network risk scores. In general, the mean is calculated as the sum of all the observations divided by the number of observations. In statistics, standard deviation (SD) is a measure of the amount of variance (e.g., spread, dispersion, etc.) that exists from the mean.

At 608, the server system 200 computes z-scores or z-values corresponding to each network risk score of the plurality of network risk scores for the plurality of cardholders. More specifically, the server system 200 computes the z-scores for the plurality of network risk scores depicted in the score table. In general, z-scores may be represented using z-distribution or the standard normal distribution. In z-distribution, the mean is 0 and the standard deviation is 1. It is to be noted that any normal distribution can be normalized by converting its values into z-scores, where z-scores provide information about the distance of standard deviations from the mean.

In addition, conversion of the normal values (i.e., the plurality of network risk scores) into corresponding z-scores makes it easier to compare the values and prioritize those risk scores from the plurality of risk scores that are highly vulnerable and that require immediate attention from the issuer server 108. More specifically, a z-score is a standard score that tells how many standard deviations away from the mean an individual value (i.e., an individual network risk score of the plurality of network risk scores) lies.

Generally, a positive z-score implies that the individual value is greater than the mean, a negative z-score implies that the individual value is less than the mean, and a z-score of zero implies that the individual value is equal to the mean. Mathematically, Z-score is calculated as:

$$Z = \frac{( x - μ )}{σ} \qquad Eqn . ( 1 )$$

Where x=individual value, μ=mean, and σ=standard deviation.

At 610, the server system 200 compares the z-scores computed in the score table to prioritize the plurality of network risk scores that need immediate attention from the issuer server 108. More specifically, the server system 200 compares the z-scores to identify the severe account-level risk that is associated with the highest z-score. In addition, the server system 200 categorizes the cardholder 104 into a group of the one or more pre-defined groups based, at least in part, on the identified severe account-level risk associated with the cardholder 104. Moreover, the server system 200 determines the overall account risk score based on the categorizing step.

At 612, the server system 200 transmits a notification to the issuer server 108 associated with the cardholder 104 based, at least in part, on the overall account risk score. More specifically, the server system 200 transmits the overall account risk score in the notification to the issuer server 108. In one implementation, the server system 200 transmits the notification of a detailed insight report to the issuer server 108. In an example, the detailed insight report may include detailed information and insights about the overall account risk score and the plurality of network risk scores corresponding to an account holder (e.g., the cardholder 104). In another example, the detailed insight report may include detailed information and insights about the overall account risk scores and the plurality of network risk scores corresponding to each of the plurality of cardholders.

In an embodiment, the overall account risk score may be represented as a combination of the type of severe account-level risk and the risk percentile. In some implementations, the type of severe account-level risk may be represented using a single alphabet and the risk percentile may be represented using a two-digit numeric value. In an example, the type of severe account-level risks may be represented using Table 1 as below:

TABLE 1
Representation of various types of account-level risks

| Output | |
|---|---|
| value | Most important risk description |
| N | No action required on this account |
| A | Immediate account reissuance required |
| B | Enablement and increased usage of contactless products |
| | to prevent fraud |
| C | Account payment capacity impact in the near term, |
| | monitor for fraud risk |
| D | High-risk channel transactions expected, drive security |
| | vigilance towards accounts truly at risk of being |
| | compromised |
| E | Suspicious account reloading patterns and |
| | monitor future wallet transactions |
| F | Chargeback likelihood and volume expected |
| | to be high, monitor purchases |

Table 1 represents the mapping of the character represented in the output of the account risk model (i.e., the overall account risk score) and the corresponding interpretation of the overall account risk score for the cardholder 104. In one example, the risk percentile may be represented using a 2-digit numeric value, including, for example, 00, 01, 02 . . . 99.

It is to be noted that it is difficult for the issuer server 108 to analyze each of the plurality of network risk scores and determine the overall account risk for the cardholder 104. In addition, it is difficult for the issuer server 108 to identify the most appropriate preventive action that needs to be performed to prevent fraudulent activity from the payment account of the corresponding cardholder 104. The overall account risk score is determined to provide a better analysis of the holistic risk factors that require immediate attention.

The sequence of steps of the method 600 need not be necessarily executed in the same order as they are presented. Further, one or more operations may be grouped together and performed in form of a single step, or one operation may have several sub-steps that may be performed in parallel or in a sequential manner.

FIG. 7 represents an example representation of a table 700 representing a plurality of network risk scores along with the overall account risk score for a plurality of cardholders (e.g., the cardholder 104), in accordance with an embodiment of the present disclosure. More specifically, the table 700 is a score table representing the plurality of network risk scores and the overall account risk score for the plurality of cardholders.

The table 700 includes a plurality of rows, a plurality of columns, and a plurality of cells, where each cell of the plurality of cells represents an intersection of a row of the plurality of rows and a column of the plurality of columns. In addition, each cell represents a value. Further, each row of the plurality of rows represents a unique identifier associated with the cardholder 104. More specifically, each row of the plurality of rows represents a cardholder (e.g., the cardholder 104) of the plurality of cardholders. With reference to FIG. 7, each row of the plurality of rows represents a cardholder C1, C2, C3, C4, and so on.

With reference to the FIG. 7, the plurality of columns represents the plurality of network risk scores, including, for example, account reissuance risk score (A), the contactless payment risk score (B), the payment capacity risk score (C), the merchant risk score (D), the account reload risk score (E), the chargeback amount prediction score (F), most severe score, group rank, and overall network risk score. In addition, each of the reissuance risk score (A), the contactless payment risk score (B), the payment capacity risk score (C), the merchant risk score (D), the account reload risk score (E), and the chargeback amount prediction score (F) is represented using two columns, namely, probability score, and z-scores, where the probability columns display the corresponding score and the z-scores column displays the corresponding z-score representation of the probability score.

It is to be noted that the negative z-scores in the table 700 represent that there is no score for the corresponding value, or the score is below a pre-defined threshold. As stated above, the processor 206 is configured to compute the z-scores corresponding to the probability values of the plurality of network risk scores. The probability values are the network risk scores computed using various risk models. The processor 206 is further configured to determine the most severe account risk (i.e., the risk type) based on the calculated z-scores of the plurality of network risk scores.

Further, the processor 206 is configured to provide a ranking to each of the plurality of cardholders based on the most severe score. The processor 206 is also configured to determine the overall account risk score based on the provided rankings to the plurality of cardholders. The table 700 represents the plurality of network risk scores (probability values and z-scores), the most severe score, the group rank, and the overall network risk score corresponding to the plurality of cardholders.

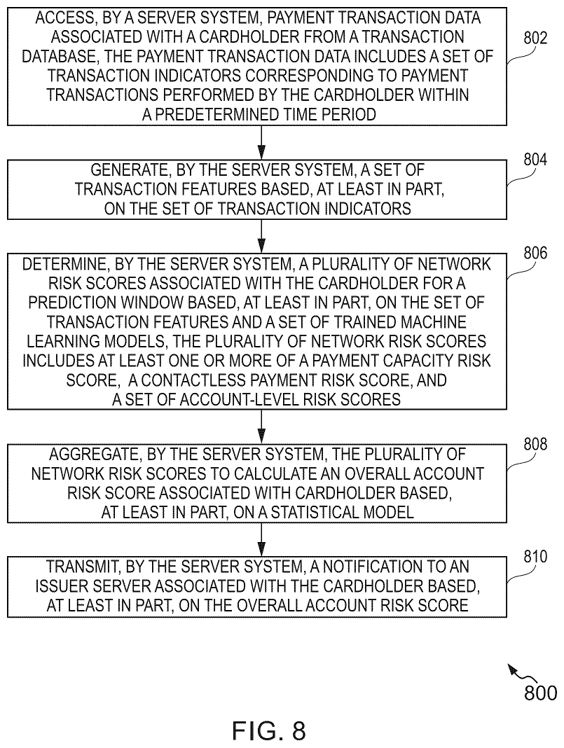

FIG. 8 is a process flow chart of a computer-implemented method 800 for calculating an overall account risk score associated with the cardholder 104, in accordance with an embodiment of the present disclosure. The method 800 depicted in the flow chart may be executed by, for example, a computer system. The computer system is identical to the server system 200. Operations of the flow chart of the method 800, and combinations of operations in the flow chart of the method 800, may be implemented by, for example, hardware, firmware, a processor, circuitry, and/or a different device associated with the execution of software that includes one or more computer program instructions. It is noted that the operations of the method 800 can be described and/or practiced by using a system other than these computer systems. The method 800 starts at operation 802.

At operation 802, the method 800 includes accessing, by the server system 200, payment transaction data associated with the cardholder 104 from the transaction database 118. The payment transaction data includes the set of transaction indicators corresponding to payment transactions performed by the cardholder 104 within a predetermined time period.

At operation 804, the method 800 includes generating, by the server system 200, the set of transaction features based, at least in part, on the set of transaction indicators.

At operation 806, the method 800 includes determining, by the server system 200, a plurality of network risk scores associated with the cardholder 104 for a prediction window based, at least in part, on the set of transaction features and a set of trained machine learning models. The plurality of network risk scores includes at least one or more of: (a) a payment capacity risk score, (b) a contactless payment risk score, and (c) a set of account-level risk scores.

At operation 808, the method 800 includes aggregating, by the server system 200, the plurality of network risk scores to calculate an overall account risk score associated with the cardholder 104 based, at least in part, on the statistical model 232.

At operation 810, the method 800 includes transmitting, by the server system 200, a notification to the issuer server 108 associated with the cardholder 104 based, at least in part, on the overall account risk score.

The sequence of operations of the method 800 need not be necessarily executed in the same order as they are presented. Further, one or more operations may be grouped together and performed in form of a single step, or one operation may have several sub-steps that may be performed in parallel or a sequential manner.

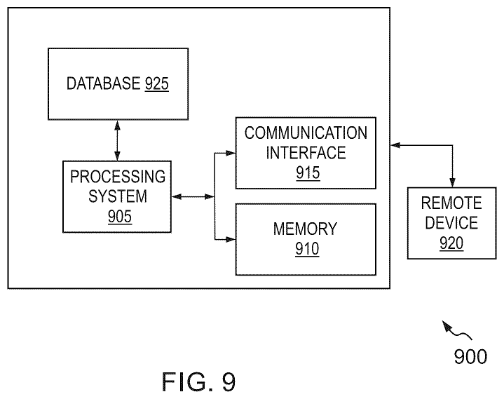

FIG. 9 is a simplified block diagram of a payment server 900, in accordance with an embodiment of the present disclosure. The payment server 900 is an example of the payment server 116 of FIG. 1. The payment server 900 and the server system 200 may use the payment network 114 as a payment interchange network. Examples of payment interchange networks include, but are not limited to, Mastercard® payment system interchange network.

The payment server 900 includes a processing system 905 configured to extract programming instructions from a memory 910 to provide various features of the present disclosure. The components of the payment server 900 provided herein may not be exhaustive and the payment server 900 may include more or fewer components than those depicted in FIG. 9. Further, two or more components may be embodied in one single component, and/or one component may be configured using multiple sub-components to achieve the desired functionalities. Some components of the payment server 900 may be configured using hardware elements, software elements, firmware elements, and/or a combination thereof.

Via a communication interface 915, the processing system 905 receives a request from a remote device 920, such as the issuer server 108 or the acquirer server 110. The request may be a request for conducting the payment transaction. The communication may be achieved through API calls, without loss of generality. The payment server 900 includes a database 925. The database 925 also includes transaction processing data such as issuer ID, country code, acquirer ID, and merchant identifier (MID), among others.

When the payment server 900 receives a payment transaction request from the acquirer server 110 or a payment terminal (e.g., point of sale (POS) device, etc.), the payment server 900 may route the payment transaction request to an issuer server (e.g., the issuer server 108). The database 925 stores transaction identifiers for identifying transaction details such as transaction amount, payment card details, acquirer account information, transaction records, merchant account information, and the like.

In one example embodiment, the acquirer server 110 is configured to send an authorization request message to the payment server 900. The authorization request message includes, but is not limited to, the payment transaction request.

The processing system 905 further sends the payment transaction request to the issuer server 108 for facilitating the payment transactions from the remote device 920. The processing system 905 is further configured to notify the remote device 920 of the transaction status in form of an authorization response message via the communication interface 915. The authorization response message includes, but is not limited to, a payment transaction response received from the issuer server 108. Alternatively, in one embodiment, the processing system 905 is configured to send an authorization response message for declining the payment transaction request, via the communication interface 915, to the acquirer server 110.

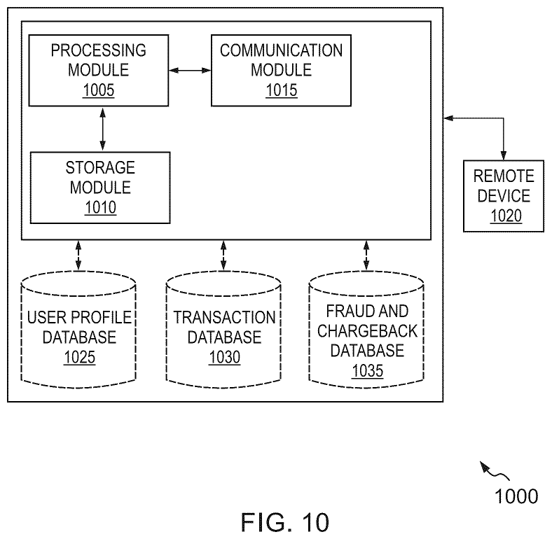

FIG. 10 is a simplified block diagram of an issuer server 1000, in accordance with an embodiment of the present disclosure. The issuer server 1000 is an example of the issuer server 108 of FIG. 1. The issuer server 1000 is associated with an issuer bank/issuer, in which an account holder (e.g., the cardholder 104) may have an account, which provides a payment card. The issuer server 1000 includes a processing module 1005 operatively coupled to a storage module 1010 and a communication module 1015. The components of the issuer server 1000 provided herein may not be exhaustive and the issuer server 1000 may include more or fewer components than those depicted in FIG. 10. Further, two or more components may be embodied in one single component, and/or one component may be configured using multiple sub-components to achieve the desired functionalities. Some components of the issuer server 1000 may be configured using hardware elements, software elements, firmware elements, and/or a combination thereof.

The storage module 1010 is configured to store machine-executable instructions to be accessed by the processing module 1005. Additionally, the storage module 1010 stores information related to, the contact information of the cardholder 104, bank account number, availability of funds in the account, payment card details, transaction details, payment account details, and/or the like. Further, the storage module 1010 is configured to store payment transactions.

In one embodiment, the issuer server 1000 is configured to store profile data (e.g., an account balance, a credit line, details of the cardholder 104, account identification information, payment card number, etc.) in the transaction database 118. The details of the cardholder 104 may include, but are not limited to, name, age, gender, physical attributes, location, registered contact number, family information, alternate contact number, registered e-mail address, or the like of the cardholder 104, etc.

The processing module 1005 is configured to communicate with one or more remote devices such as a remote device 1020 using the communication module 1015 over a network such as the network 112 of FIG. 1. The examples of the remote device 1020 include the server system 200, the payment server 116, the transaction database 118 or other computing systems of the issuer server 1000 and the network 112 and the like. The communication module 1015 is capable of facilitating such operative communication with the remote devices and cloud servers using API (Application Program Interface) calls. The communication module 1015 is configured to receive a payment transaction request performed by the account holder (e.g., the cardholder 104) via the network 112. The processing module 1005 receives a payment card information, a payment transaction amount, customer information, and merchant information from the remote device 1020 (e.g., the payment server 116). The issuer server 1000 includes a transaction database 1030 for storing transaction data. In an example, the transaction database 1030 is similar to the transaction database 118. The transaction data may include, but is not limited to, transaction attributes, such as transaction amount, source of funds such as bank or credit cards, transaction channel used for loading funds such as POS terminal or ATM machine, transaction velocity features such as count and transaction amount sent in the past x days to a particular account holder, transaction location information, external data sources, and other internal data to evaluate each transaction. The issuer server 1000 includes a user profile database 1025 storing user profiles associated with the plurality of account holders.

In one embodiment, the issuer server 1000 is also configured to store historical fraudulent chargeback activities associated with the plurality of account holders (e.g., the cardholder 104) in a fraud and chargeback database 1035. The user profile data may include an account balance, a credit line, details of the account holder (e.g., the cardholder 104), account identification information, payment card number, or the like. The details of the account holder (e.g., the cardholder 104) may include, but are not limited to, name, age, gender, physical attributes, location, registered contact number, family information, alternate contact number, registered e-mail address, or the like of the account holder (e.g., the cardholder 104).

The disclosed methods with reference to FIGS. 1 to 10, or one or more operations of the methods 600 and 800 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components)) and executed on a computer (e.g., any suitable computer, such as a laptop computer, netbook, Webbook, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the disclosure has been described with reference to specific exemplary embodiments, it is noted that various modifications and changes may be made to these embodiments without departing from the broad spirit and scope of the disclosure. For example, the various operations, blocks, etc. described herein may be enabled and operated using hardware circuitry (for example, complementary metal-oxide-semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, application-specific integrated circuit (ASIC) circuitry and/or Digital Signal Processor (DSP) circuitry).

Particularly, the server system 200 (e.g., the server system 102) and its various components such as the computer system 202 and the database 204 may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g., magneto-optical disks), CD-ROM (compact disc read-only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. (canceled)

2. A computer-implemented method, comprising:
accessing, by a server system, payment transaction data associated with each cardholder of a plurality of cardholders from a transaction database, the payment transaction data comprising a plurality of transaction indicators of payment transactions performed by each cardholder of the plurality of cardholders within a predetermined time period;
generating, by the server system, a set of transaction features based, at least in part, on the plurality of transaction indicators;
determining, by the server system, a plurality of network risk scores associated with each cardholder of the plurality of cardholders for a prediction window based, at least in part, on the set of transaction features and a set of trained machine learning models, the plurality of network risk scores comprising: (a) a payment capacity risk score, (b) a contactless payment risk score, and (c) a set of account-level risk scores;
aggregating, by the server system, the plurality of network risk scores to calculate an overall account risk score associated with each cardholder of the plurality of cardholders based, at least in part, on a statistical model;
wherein the payment capacity risk score is determined by the following:
calculating, by the server system, a credit burst score, based at least in part, on spend behavioral data associated with each cardholder of the plurality of cardholders;
determining, by the server system, whether the credit burst score being at least equal to a pre-defined threshold value; and
in response to determining that the credit burst score is at least equal to the pre-defined threshold value, determining, by the server system, an account attrition score and a non-sufficient funds (NSF) score associated with each cardholder of the plurality of cardholders;
based on the overall account risk score for each cardholder of the plurality of cardholders, determining a most vulnerable risk that is likely to happen in future from a payment account of a cardholder of the plurality of cardholders; and
based, at least in part, on the most vulnerable risk being likely to happen from the payment account of the cardholder of the plurality of cardholders, causing, by the server system, a preventive action for only the most vulnerable risk, the preventive action reducing the most vulnerable risk.

3. The computer-implemented method as claimed in claim 2, wherein reducing the most vulnerable risk comprises eliminating the most vulnerable risk.

4. The computer-implemented method as claimed in claim 2, wherein the payment capacity risk score is determined based, at least in part, on the combination of the account attrition score and the NSF score associated with the cardholder.

5. The computer-implemented method as claimed in claim 4, wherein:
the account attrition score associated with the cardholder is based, at least in part, on an account attrition model, the account attrition score indicating a likelihood of the cardholder being spend inactive within the prediction window; and
the NSF decline score associated with the cardholder is based, at least in part, on a NSF prediction model, the NSF decline score indicating a likelihood of having payment declines due to insufficient funds in the payment account of the cardholder within the prediction window.

6. The computer-implemented method as claimed in claim 5, wherein the account attrition model and the NSF prediction model are trained based at least on a gradient boosting decision tree method.

7. The computer-implemented method as claimed in claim 2, wherein the preventive action is taken to eliminate the most vulnerable risk beforehand, and wherein no computing resources are allocated to risks that are not the most vulnerable risk.

8. The computer-implemented method as claimed in claim 2, wherein the contactless payment risk score is determined based, at least in part, on a contactless risk prediction model and a combination of a contactless wallet risk score and a contactless card risk score associated with the cardholder.

9. The computer-implemented method as claimed in claim 2, wherein, to calculate the overall account risk score, the computer-implemented method further comprises:
providing, by the server system, the plurality of network risk scores associated with the cardholder as an input to the statistical model;
determining, by the server system, one or more statistical parameters associated with each of the plurality of network risk scores;
computing, by the server system, a set of z-scores corresponding to the plurality of network risk scores;
comparing, by the server system, the set of z-scores to identify a severe account-level risk that is associated with a highest z-score;
categorizing, by the server system, the cardholder into a group of one or more pre-defined groups based, at least in part, on the identified severe account-level risk associated with the cardholder; and
calculating, by the server system, the overall account risk score associated with the cardholder based, at least in part, on the categorizing.

10. A server system, comprising:
a communication interface;
a memory comprising executable instructions; and
a processor communicably coupled to the communication interface and the memory, the processor configured to execute the instructions to cause the server system, at least in part, to:
access payment transaction data associated with each cardholder of a plurality of cardholders from a transaction database, the payment transaction data comprising a plurality of transaction indicators of payment transactions performed by each cardholder of the plurality of cardholders within a predetermined time period;
generate a set of transaction features based, at least in part, on the plurality of transaction indicators;
determine a plurality of network risk scores associated with each cardholder of the plurality of cardholders for a prediction window based, at least in part, on the set of transaction features and a set of trained machine learning models, the plurality of network risk scores comprising (a) a payment capacity risk score, (b) a contactless payment risk score, and (c) a set of account-level risk scores;
aggregate the plurality of network risk scores to calculate an overall account risk score associated with each cardholder of the plurality of cardholders based, at least in part, on a statistical model;
wherein the payment capacity risk score is determined by the following:
calculating, by the server system, a credit burst score, based at least in part, on spend behavioral data associated with each cardholder of the plurality of cardholders;
determining, by the server system, whether the credit burst score being at least equal to a pre-defined threshold value; and
in response to determining that the credit burst score is at least equal to the pre-defined threshold value, determining, by the server system, an account attrition score and a non-sufficient funds (NSF) score associated with each cardholder of the plurality of cardholders:
based on the overall account risk score for each cardholder of the plurality of cardholders, determine a most vulnerable risk that is likely to happen in future from a payment account of a cardholder of the plurality of cardholders; and
based, at least in part, on the most vulnerable risk being likely to happen from the payment account of the cardholder of the plurality of cardholders, cause, by the server system, a preventive action for only the most vulnerable risk, the preventive action reducing the most vulnerable risk.

11. The server system as claimed in claim 10, wherein the preventive action is taken to eliminate the most vulnerable risk beforehand, and wherein no computing resources are allocated to risks that are not the most vulnerable risk.

12. The server system as claimed in claim 11, wherein the payment capacity risk score is determined based, at least in part, on the combination of the account attrition score and the NSF score associated with the cardholder.

13. The server system as claimed in claim 12, wherein:
the account attrition score associated with the cardholder is based, at least in part, on an account attrition model, the account attrition score indicating a likelihood of the cardholder being spend inactive within the prediction window; and
the NSF decline score associated with the cardholder is based, at least in part, on a NSF prediction model, the NSF decline score indicating a likelihood of having payment declines due to insufficient funds in the payment account of the cardholder within the prediction window.

14. The server system as claimed in claim 13, wherein the account attrition model and the NSF prediction model are trained based at least on a gradient boosting decision tree method.

15. The server system as claimed in claim 10, wherein reducing the most vulnerable risk comprises eliminating the most vulnerable risk.

16. The server system as claimed in claim 15, wherein, to calculate the overall account risk score, the server system is further caused, at least in part, to:
provide the plurality of network risk scores associated with the cardholder as an input to the statistical model;
determine one or more statistical parameters associated with each of the plurality of network risk scores;
compute a set of z-scores corresponding to the plurality of network risk scores; compare the set of z-scores to identify a severe account-level risk that is associated with a highest z-score; and
categorize the cardholder into a group from one or more pre-defined groups based, at least in part, on the identified severe account-level risk associated with the cardholder; and calculate the overall account risk score associated with the cardholder based, at least in part, on the categorization.

17. A non-transitory computer-readable storage medium comprising computer-executable instructions that, when executed by at least a processor of a server system, cause the server system to perform a method comprising:
accessing payment transaction data associated with each cardholder of a plurality of cardholders from a transaction database, the payment transaction data comprising a plurality of transaction indicators of payment transactions performed by each cardholder of the plurality of cardholders within a predetermined time period;
generating a set of transaction features based, at least in part, on the plurality of transaction indicators;
determining, by the server system, a plurality of network risk scores associated with each cardholder of the plurality of cardholders for a prediction window based, at least in part, on the set of transaction features and a set of trained machine learning models, the plurality of network risk scores comprising: (a) a payment capacity risk score, (b) a contactless payment risk score, and (c) a set of account-level risk scores;
aggregating the plurality of network risk scores to calculate an overall account risk score associated with each cardholder of the plurality of cardholders based, at least in part, on a statistical model;
wherein the payment capacity risk score is determined by the following:
calculating, by the server system, a credit burst score, based at least in part, on spend behavioral data associated with each cardholder of the plurality of cardholders;
determining, by the server system, whether the credit burst score being at least equal to a pre-defined threshold value; and
in response to determining that the credit burst score is at least equal to the pre-defined threshold value, determining, by the server system, an account attrition score and a non-sufficient funds (NSF) score associated with each cardholder of the plurality of cardholders;
based on the overall account risk score for each cardholder of the plurality of cardholders, determining a most vulnerable risk that is likely to happen in future from a payment account of a cardholder of the plurality of cardholders; and
based, at least in part, on the most vulnerable risk being likely to happen from the payment account of the cardholder of the plurality of cardholders, causing, by the server system, a preventive action for only the most vulnerable risk, the preventive action reducing the most vulnerable risk.

18. The non-transitory computer-readable storage medium as claimed in claim 17, wherein the payment capacity risk score is determined based, at least in part, on the combination of the account attrition score and the NSF score associated with the cardholder.

19. The non-transitory computer-readable storage medium as claimed in claim 18, wherein:
the account attrition score associated with the cardholder is based, at least in part, on an account attrition model, the account attrition score indicating a likelihood of the cardholder being spend inactive within the prediction window; and
the NSF decline score associated with the cardholder is based, at least in part, on a NSF prediction model, the NSF decline score indicating a likelihood of having payment declines due to insufficient funds in the payment account of the cardholder within the prediction window.

20. The non-transitory computer-readable storage medium as claimed in claim 19, wherein, to calculate the overall account risk score, the method further comprises:
providing the plurality of network risk scores associated with the cardholder as an input to the statistical model;
determining one or more statistical parameters associated with each of the plurality of network risk scores;
computing a set of z-scores corresponding to the plurality of network risk scores; comparing the set of z-scores to identify a severe account-level risk that is associated with a highest z-score; and
categorizing the cardholder into a group of one or more pre-defined groups based, at least in part, on the identified severe account-level risk associated with the cardholder; and calculating the overall account risk score associated with the cardholder based, at least in part, on the categorizing.

21. The non-transitory computer-readable storage medium as claimed in claim 17, wherein the preventive action is taken to eliminate the most vulnerable risk beforehand, and wherein no computing resources are allocated to risks that are not the most vulnerable risk.
